(19) United States
(12) Patent Application Publication
(10) Pub. No.: US 2007/0217623 A1
(43) Pub. Date: Sep. 20, 2007

(54) APPARATUS AND METHOD FOR REAL-TIME PROCESSING

(75) Inventor: Noriyuki HARADA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/685,988

(22) Filed: Mar. 14, 2007

(30) Foreign Application Priority Data
Mar. 15, 2006 (JP) 2006-071623

(51) Int. Cl. H04B 15/00; G06K 9/40

(52) U.S. Cl. 381/94.1; 382/254

(57) ABSTRACT

There is provided a real-time processing apparatus capable of controlling power consumption without performing complex arithmetic processing and requiring a special memory resource. The real-time processing apparatus includes a first audio encoder 104 that performs a signal processing in real time on an audio signal, a second audio encoder 111 that performs the signal processing with a smaller throughput in real time on the audio, an audio execution step number notification unit 114 that measures step number showing a level of the throughput in the signal processing by operating the first audio encoder 104 or second audio encoder 111, and an audio visual system control unit 117 that executes control so that the first audio encoder 104 operates when the measured step number is less than a threshold value provided beforehand and the second audio encoder 111 operates when the step number is equal to or greater than the threshold value.

### BACKGROUND OF THE INVENTION

(1) Field of the Invention

The present invention relates to a real-time processing apparatus that processes an input signal in real time and, more particularly, to a technique that reduces power consumption of the real-time processing apparatus.

(2) Description of the Related Art

The technique to control power, such as voltages and clocks, dynamically according to stream characteristics in an MPEG (Moving Picture Experts Group) decoder is proposed as a technique that reduces power consumption in a conventional real-time processing apparatus (see, for example, Japanese Unexamined Patent Application Publication No. 2004-153553).

In this prior art, in the decoder, power consumption has been reduced by calculating the average processing time only according to the characteristic of the stream, determining the throughput according to the value, and controlling either the voltage or the clock dynamically.

However, in the above-mentioned prior art, the power control uses the average processing time in the decoder. Therefore, there is a problem of needing the complex arithmetic processing of calculating the average processing time, as well as needing a memory resource for accumulating the processing time of each picture for the calculation of the average processing time. Therefore, there is a problem of uselessly consuming the resources of the CPU and the memory, etc. Moreover, the above-mentioned prior art also has a problem of being intended only for the video decoder.

### SUMMARY OF THE INVENTION

The present invention is conceived in view of the aforementioned problems and an object thereof is to provide a real-time processing apparatus etc. that can control power consumption, without performing complex arithmetic processing and requiring a special memory resource.

In order to achieve the aforementioned object, the real-time processing apparatus according to the present invention is a real-time processing apparatus which processes an input signal in real time, the real-time processing apparatus including: a first signal processing unit which performs signal processing in real time on the input signal; a second signal processing unit which performs the signal processing with throughput smaller than throughput of the signal processing by the first signal processing unit, in real time on the input signal; a step number measurement unit which measures a step number indicating a level of the throughput in the signal processing by the first signal processing unit or the second signal processing unit which is in operation; and a controlling unit which executes control so that the first signal processing unit operates when the step number measured by the step number measurement unit is less then a threshold value provided beforehand, and the second signal processing unit operates when the step number is equal to or greater than the threshold value. Accordingly, the power saving is controlled on the basis of the comparison result between the throughput in the signal processing unit and the threshold value, and thus, power consumption can be controlled without performing complex arithmetic processing such as the calculation of the average processing time etc. and without requiring a memory for the average processing. Moreover, since the power saving control is performed by simple processing, it is applicable not only to the decoding of the audio and the video signal but also to the encoding of the audio and the video signal.

Here, “real-time signal processing” means that inputted signals are not accumulated and queued, and signal processing is performed in real time. For example, this refers to processing which carries out compression encoding on the inputted audio signal and video signal, then multiplexes both, and records the multiplexed result in a recording medium, without accumulating those signals. The present invention is implemented as a real real-time processing apparatus because the present invention is a technique suitable for an apparatus that performs signal processing in real time, since it carries out power saving control through a simple mechanism.

In addition, it is also possible that the controlling unit includes: a step number determination unit which compares the step number with the threshold value; and a signal processing mode selection unit having a signal processing mode selection table, and which selects, according to the signal processing mode selection table, a signal processing mode corresponding to a comparison result by the step number determination unit, the signal processing mode selection table indicating a correspondence between the comparison result by the step number determination unit and the signal processing mode which indicates an operation mode of the first signal processing unit and the second signal processing unit, and the controlling unit executes control of the operation of the first signal processing unit and the second signal processing unit according to the signal processing mode selected by the signal processing mode selection unit. Accordingly, since the signal processing mode is determined by merely referring to the table after the comparison of the step number and the threshold value is performed, a simple, high-speed power saving control becomes possible.

Moreover, it is also possible that the input signal includes an audio signal and a video signal, the first signal processing unit includes: a first audio processing unit which processes the audio signal; and a first video processing unit which processes the video signal, the second signal processing unit includes: a second audio processing unit which processes the audio signal with throughput smaller than the throughput in the first audio processing unit; and a second video processing unit which processes the video signal with throughput smaller than the throughput in the first video processing unit, the step number measurement unit includes: an audio processing step number measurement unit which measures the step number of the first audio processing unit or the second audio processing unit which is in operation; and a video processing step number measurement unit which measures the step number of the first video processing unit or the second video processing unit which is in operation, and the controlling unit executes control so that: the first audio processing unit operates when the number of steps measured by the audio processing step number measurement unit is smaller than the threshold value, and the second audio processing unit operates when the number of steps is equal to or greater than the threshold value; and the first video processing unit operates when the number of steps measured by the video processing step number measurement unit is smaller than the threshold value, and the second video processing unit operates when the number of steps is equal to or greater than the threshold value. Accordingly, the real-time processing apparatus according to the present invention is implemented as an encoder and a decoder of the video signal.

Here, it is possible that the real-time processing apparatus may further include a quality mode determination unit which determines which of audio quality or video quality is to be given priority, wherein the signal processing mode selection unit has, as the signal processing mode selection table: an audio priority selection table for carrying out signal processing with priority being given to audio signal quality; and a video priority selection table for carrying out signal processing with priority being given to video signal quality, and selects the signal processing mode according to the audio priority selection table when the quality mode determination unit determines to give priority to the audio quality, and to select the signal processing mode according to the video priority selection table when the quality mode determination unit determines to give priority to the video quality. Accordingly, an encoder and a decoder of low power consumption which reflects the preference of the user as to which of audio quality or video quality should be given priority are realized.

Moreover, it is also possible that the video processing step number measurement unit measures, as the step number: the size of a motion vector of the video detected by the first video processing unit or the second video processing unit which is in operation; the throughput of the resulting signal after the audio signal and video signal are multiplexed; and the electric current consumption in the real-time processing apparatus. All are simple measurements, and thus power consumption can be reduced without performing complex arithmetic processing and requiring the resource of the memory etc.

Moreover, it is possible that the controlling unit includes a clock control unit which lowers a frequency of a clock signal supplied to the first signal processing unit and the second signal processing unit when the step number measured by the step number measurement unit is equal to or greater than the threshold value provided beforehand. Accordingly, aside from the ON/OFF control of each component, power saving control through the adjustment of the frequency of the clock signal supplied to each component is also carried out, and thus, power consumption can be further reduced.

Moreover, it is also possible that the real-time processing apparatus further includes a step number hold unit which holds the step number measured by the step number measurement unit. Accordingly, the real-time processing apparatus further includes a decoding unit which decodes the encoded audio signal and the encoded video signal, and the controlling unit includes a clock control unit which lowers a frequency of a clock signal supplied to the decoding unit when the step number held by the step number hold unit is equal to or greater than the threshold value provided beforehand. Therefore, the step number when the audio and the video signal are encoded can be used in the power saving control at the time of decoding.

Moreover, it is also possible that the real-time processing apparatus further includes: a multiplex unit which multiplexes the audio signal obtained by the first audio processing unit or the second audio processing unit and the video signal obtained by the first video processing unit or the second video processing unit; and a user information addition unit which adds the held step number held by the step number hold unit, as user information, to the multiplexed signals obtained by the multiplex unit. Accordingly, the real-time processing apparatus further includes a decoding unit which de-multiplexes the multiplexed signals to which the step number is added by the user information addition unit, and decodes the de-multiplexed signals, and the controlling unit includes a clock control unit which lowers a frequency of a clock signal supplied to the decoding unit when the step number added to the multiplexed signals is equal to or greater than the threshold value provided beforehand. Therefore, the step number when the audio and the video signal are encoded can be used in the power saving control at the time of decoding.

Moreover, it is also possible that the real-time processing apparatus further includes: a first communication unit which transmits the multiplexed signals to which the step number is added by the user information addition unit via a communication network; and a second communication unit which receives the multiplexed signals to which the step number is added, which is transmitted via the communication network, wherein the decoding unit de-multiplexes the multiplexed signals received by the second communication unit, and to decode the de-multiplexed signals. Accordingly, in the communication system configured of the transmitter and the receiver, the step number when the audio and the video signal are encoded can be used in the power saving control at the time of decoding.

In addition, the present invention can be implemented, not only as a real-time processing apparatus, but also as a real-time processing method having each processing unit included in the real-time processing apparatus as steps. Moreover, the present invention can also be implemented as a program that causes a computer to execute the steps included in the real-time processing method, and also as a computer-readable recording medium on which the program is recorded.

According to the present invention, it is possible to implement a real-time processing apparatus in which power consumption is controlled merely by the simple process of comparing the throughput and the threshold value, without performing complex arithmetic processing and requiring a special memory resource. Moreover, not only decode of the audio signal and the video signal but also such real-time processing apparatus can be applied to encode of the audio signal and the video signal.

Therefore, according to the present invention, a real-time processing apparatus which promotes power saving is realized and, in particular, power consumption during encoding and decoding of audio and video signals is reduced, and thus the practical value of the present invention in these times of progressing miniaturization of AV devices is extremely high.

### FURTHER INFORMATION ABOUT TECHNICAL BACKGROUND TO THIS APPLICATION

The disclosure of Japanese Patent Application No. 2006-071623 filed on Mar. 15, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a real-time processing apparatus according to the first embodiment of the present invention;

FIG. 2 is a schematic diagram showing a configuration of a power threshold value table;

FIG. 3 is a schematic diagram showing a configuration of a signal processing mode selection table (filter control);

FIG. 4 is a schematic diagram showing a configuration of the signal processing mode selection table (CODEC switching);

FIG. 5 is a schematic diagram showing a configuration of the signal processing mode selection table (parameter switch for the picture quality adjustment);

FIG. 6 is a flow chart showing an operation of the real-time processing apparatus according to the first embodiment of the present invention;

FIG. 7 is a block diagram showing a configuration of the real-time processing apparatus according to the second embodiment of the present invention;

FIG. 8 is a schematic diagram showing a configuration of the signal processing mode selection table (audio priority);

FIG. 9 is a schematic diagram showing a configuration of the signal processing mode selection table (video priority);

FIG. 10 is a flow chart showing an operation of the real-time processing apparatus according to the second embodiment of the present invention;

FIG. 11 is a block diagram showing a configuration of the real-time processing apparatus according to the third embodiment of the present invention;

FIG. 12 is a schematic diagram showing a configuration of a power threshold value table (motion vector);

FIG. 13 is a schematic diagram showing a configuration of the signal processing mode selection table (motion vector);

FIG. 14 is a flow chart showing an operation of the real-time processing apparatus according to the third embodiment of the present invention;

FIG. 15 is a block diagram showing a configuration of the real-time processing apparatus according to the fourth embodiment of the present invention;

FIG. 16 is a schematic diagram showing a configuration of the power threshold value table (throughput);

FIG. 17 is a schematic diagram showing a configuration of the signal processing mode selection table (throughput/audio priority);

FIG. 18 is a schematic diagram showing a configuration of the signal processing mode selection table (throughput/video priority);

FIG. 19 is a flow chart showing an operation of the real-time processing apparatus according to the fourth embodiment of the present invention;

FIG. 20 is a block diagram showing a configuration of the real-time processing apparatus according to the fifth embodiment of the present invention;

FIG. 21 is a schematic diagram showing a configuration of the signal processing mode selection table (clock control);

FIG. 22 is a block diagram showing a configuration of the real-time processing apparatus according to the sixth embodiment of the present invention;

FIG. 23 is a schematic diagram showing a configuration of the power threshold value table (electric current consumption);

FIG. 24 is a schematic diagram showing a configuration of the signal processing mode selection table (electric current consumption/audio priority);

FIG. 25 is a schematic diagram showing a configuration of the signal processing mode selection table (electric current consumption/video priority);

FIG. 26 is a block diagram showing a configuration of the real-time processing apparatus according to the seventh embodiment of the present invention;

FIG. 27 is a schematic diagram showing a configuration of the execution step number hold table;

FIG. 28 is a block diagram showing a configuration of the real-time processing apparatus according to the eighth embodiment of the present invention;

FIG. 29 is a schematic diagram showing a data configuration of the multiplex stream to which user information is added;

FIG. 30 is a block diagram showing a configuration of the real-time processing apparatus according to the ninth embodiment of the present invention;

FIG. 31 is a flow chart showing an operation of the real-time processing apparatus according to the ninth embodiment of the present invention;

FIG. 32 is a block diagram showing a configuration of the real-time processing apparatus according to the tenth embodiment of the present invention;

FIG. 33 is a block diagram showing a configuration of the real-time processing apparatus according to the eleventh embodiment of the present invention; and

FIG. 34 is a block diagram showing a configuration of the real-time processing apparatus according to the twelfth embodiment of the present invention.

### DESCRIPTION OF THE PREFERRED EMBODIMENTS

Hereafter, the embodiments of the present invention will be described in detail with reference to the accompanying drawings.

### First Embodiment

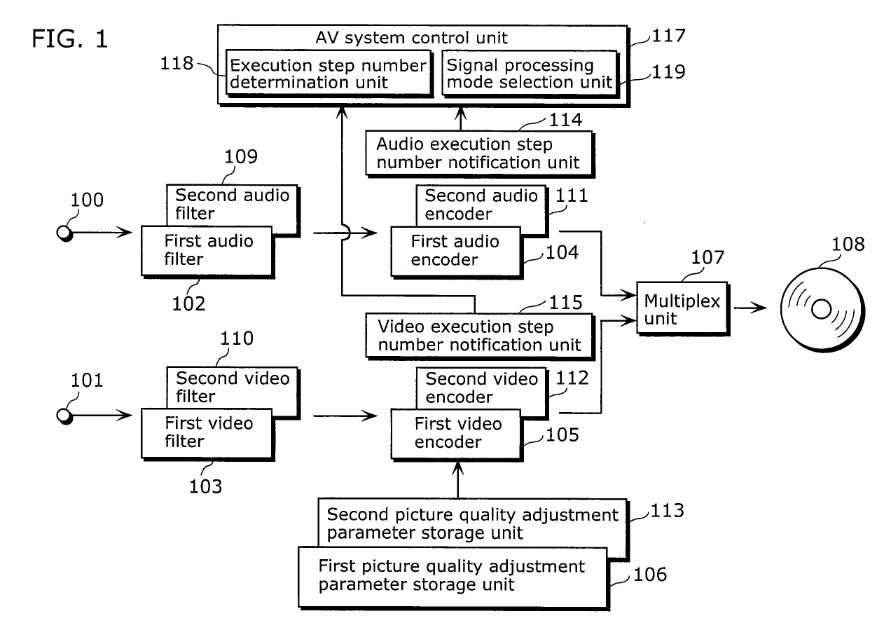

FIG. 1 is a block diagram showing a configuration of a real-time processing apparatus according to the first embodiment of the present invention. This real-time processing apparatus is a recorder that in real time encodes then multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and second picture quality adjustment parameter storage unit 113) that can be selectively used, an AV (audio visual) system control unit 117, a multiplex unit 107, and the recording medium 108.

The first audio filter 102 and second audio filter 109 are the digital filters for the audio signal. The second audio filter 109 executes a filter operation with an amount of processing which is smaller than in the first audio filter 102, for example, a filter operation according to a characteristic equation with few degrees (number of coefficients).

The first audio encoder 104 and the second audio encoder 111 are encoders for the audio signal, and respectively compress and encode, for instance, according to AC3 (Audio Code Number 3) and MPEG1 Layer2. That is, the second audio encoder 111 is an encoder which carries out compression and coding with an amount of processing smaller than the first audio encoder 104.

In addition, the first audio filter 102 and second audio filter 109 are used as a set with the corresponding first audio encoder 104 and the second audio encoder 111, respectively. In other words, either the first set of the first audio filter 102 and the first audio encoder 104 or the second set of the second audio filter 109 and the second audio encoder 111 is used alternatively.

The audio execution step number notification unit 114 is a processing unit that repeats, for each frame, the measurement of the throughput per frame (number of execution steps/frame) of the operating audio encoder (the first audio encoder 104 or the second audio encoder 111) and the notification thereof to the audio visual system control unit 117. Here, the frame may be a frame of the audio signal inputted to the audio encoder, and may also be a video frame (picture).

The first video filter 103 and the second video filter 110 are the digital filters for the video signal. The second video filter 110 executes a filter operation with an amount of processing smaller than the first video filter 103, for example, the filter operation according to a characteristic equation with few degrees (number of coefficients).

The first video encoder 105 and the second video encoder 112 are encoders for the video signal, and respectively compress and encode, for instance, according to MPEG2 and MPEG4. That is, the second video encoder 112 is an encoder which carries out compression and encoding with an amount of processing smaller than the first video encoder 105.

The video execution step number notification unit 115 is a processing unit that repeats, for each frame, the measurement of the throughput per frame (number of execution steps/frame) of the operating video encoder (the first video encoder 105 or the second video encoder 112) and the notification thereof to the audio visual system control unit 117. Here, the frame means a frame (picture) of the video signal inputted to the video encoder.

In addition, the first video filter 103 and the second video filter 110 are used as a set with the corresponding first video encoder 105 and the second video encoder 112, respectively. In other words, either the first set of the first video filter 103 and the first video encoder 105 or the second set of the second video filter 110 and the second video encoder 112 is used alternatively.

The first picture quality adjustment parameter storage unit 106 and the second picture quality adjustment parameter storage unit 113 are the memories etc. that are the storage of the picture quality adjustment parameter used by the first video encoder 105 and the second video encoder 112. The first picture quality adjustment parameter storage unit 106 and the second picture quality adjustment parameter storage unit 113 hold a picture quality adjustment parameter for achieving high picture quality compression and encoding and a picture quality adjustment parameter for achieving low picture quality compression and encoding, respectively. In other words, the second picture quality adjustment parameter storage unit 113 holds a parameter for compression and encoding that can make do with throughput smaller than the first picture quality adjustment parameter storage unit 106.

The audio visual system control unit 117 is a processor etc. that decides respective notifications (for example, each audio frame and each video frame) and the signal processing mode to achieve the power reduction, based on the number of execution steps notified from the audio execution step number notification unit 114 and the video execution step number notification unit 115, and performs control so that each component 102 to 107 and 109 to 113 operate (or do not operate) according to the decided signal processing mode. The audio visual system control unit 117 includes an execution step number determination unit 118 and a signal processing mode selection unit 119.

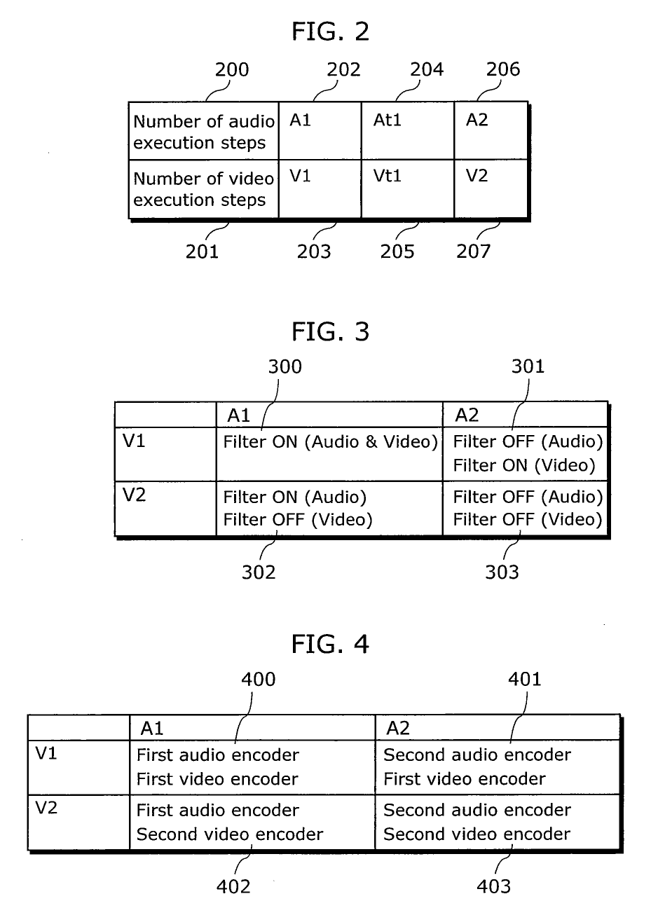

The execution step number determination unit 118 compares the threshold values set beforehand with the respective number of execution steps notified from the audio execution step number notification unit 114 and the video execution steps number notification unit 115. Here, as shown in a power threshold value table shown in FIG. 2, the execution step number determination unit 118 compares the number of audio execution steps 200 notified from audio execution steps number notification unit 114 with audio execution step number threshold value At1 (204), and notifies the result to the signal processing mode selection unit 119. Note that, hereafter, the case where the number of audio execution steps 200 is less than the threshold value At1 (204) of audio execution steps shall be referred to as “A1 (202)”, and the case where the number of audio execution steps 200 is equal to or greater than the threshold value At1 (204) of audio execution steps is called “A2 (206)”.

Similarly, the execution step number determination unit 118 compares number of video execution steps 201 notified from videos execution steps number notification unit 115 with video execution step number threshold value Vt1 (205), and notifies the result to the signal processing mode selection unit 119. Note that, hereafter, the case where the number of video execution steps 201 is less than the threshold value Vt1 (205) of video execution steps is called “V1 (203)”, and the case where the number of video execution steps 201 is equal to or greater than the threshold value Vt1 (205) of video execution steps is called “V2 (207)”.

The signal processing mode selection unit 119 is a processing unit which selects the signal processing mode on the basis of the comparison result in the execution step number determination unit 118, and includes, as a decision table for that purpose, a signal processing mode selection table shown in FIG. 3 to FIG. 5.

FIG. 3 is a diagram showing a signal processing mode selection table for filter control. This signal processing mode selection table is a decision table for controlling the filter so as to decrease the number of execution steps when the number of execution steps is equal to or greater than a constant threshold value. The signal processing mode selection table shows the following. In other words, the filters of audio and video are turned ON, as shown in area 300 in FIG. 3, when the number of audio execution steps is A1 (202) and the number of video execution steps is V1 (203). Moreover, the audio filter is turned OFF and the video filter is turned ON, as shown in area 301 in FIG. 3, when the number of audio execution steps is A2 (206) and the number of video execution steps is V1 (203) as shown in area 301 in FIG. 3. Moreover, the audio filter is turned ON and the video filter is turned OFF, as shown in area 302 in FIG. 3, when the number of audio execution steps is A1 (202) and the number of video execution steps is V2 (207). Moreover, the audio filter is turned OFF and the video filter is turned OFF, as shown in area 303 in FIG. 3, when the number of audio execution steps is A2 (206) and the number of video execution steps is V2 (207).

The signal processing mode selection unit 119 selects, according to the signal processing mode selection table shown in FIG. 3, the signal processing mode that turns ON or turns OFF the audio filter selected from among the first audio filter 102 and second audio filter 109, and turns ON or turns OFF the video filter selected from among the first video filter 103 and second video filter 110.

FIG. 4 is a diagram showing a signal processing mode selection table for CODEC (referred to here as encoder) switching. This signal processing mode selection table is a decision table for switching the encoder so as to decrease the number of execution steps when the number of execution steps is equal to or greater than a constant threshold value, and shows the following. In other words, the first audio encoder 104 and the first video encoder 105 are selected as the combination of the audio encoder and video encoder to be operated, as shown in area 400 in FIG. 4, when the number of audio execution steps is A1 (202) and the number of video execution steps is V1 (203). Moreover, the second audio encoder 111 and the first video encoder 105 are selected as the combination of the audio encoder and video encoder to be operated, as shown in area 401 in FIG. 4, when the number of audio execution steps is A2 (206) and the number of video execution steps is V1 (203). Moreover, the first audio encoder 104 and the second video encoder 112 are selected as the combination of the audio encoder and video encoder, as shown in area 402 in FIG. 4, when the number of audio execution steps is A1 (202) and the number of video execution steps is V2 (207). Moreover, the second audio encoder 111 and the second video encoder 112 are selected as the combination of the audio encoder and video encoder to be operated, as shown in area 403 in FIG. 4, when the number of audio execution steps is A2 (206) and the number of video execution steps is V2 (207).

The signal processing mode selection unit 119 selects, according to the signal processing mode selection table shown in FIG. 4, the signal processing mode that operates either the first audio encoder 104 or second audio encoder 111, and operates either the first video encoder 105 or the second video encoder 112.

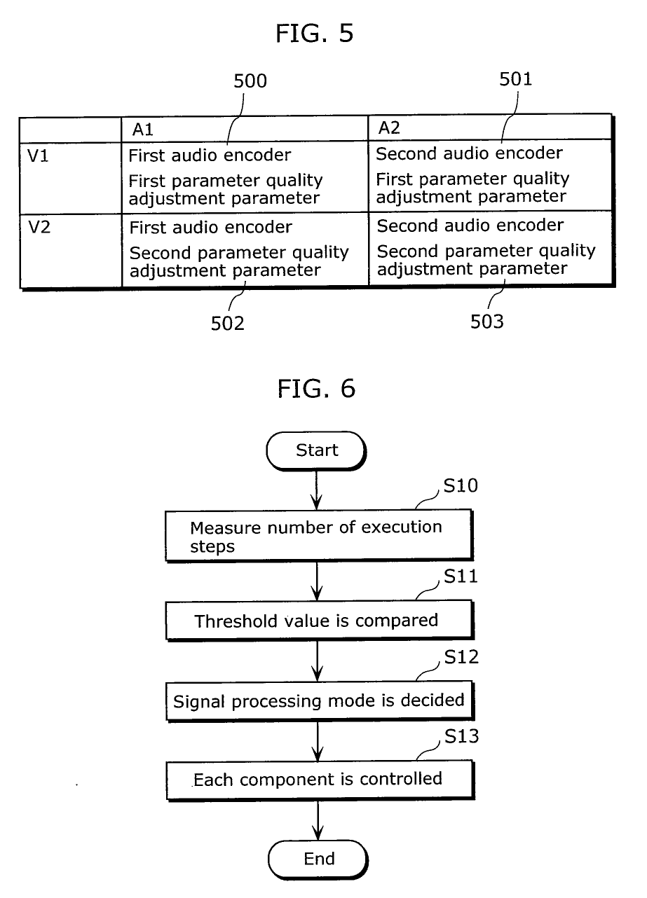

FIG. 5 is a diagram showing a signal processing mode selection table for switching the picture quality adjustment parameter. This signal processing mode selection table is a decision table for switching the picture quality adjustment parameter so as to decrease the number of execution steps when the number of execution steps is equal to or greater than a constant threshold value. The signal processing mode selection table shows the following. In other words, the first audio encoder 104 and first picture quality adjustment parameter storage unit 106 are selected as the combination of the audio encoder to be operated and the read-source of the picture quality adjustment parameter to be used by the video encoder, as shown in area 500 in FIG. 5, when the number of audio execution steps is A1 (202) and the number of video execution steps is V1 (203). Moreover, the second audio encoder 111 and first picture quality adjustment parameter storage unit 106 are selected as the combination of the audio encoder to be operated and the read-source of the picture quality adjustment parameter to be used by the video encoder, as shown in area 501 in FIG. 5, when the number of audio execution steps is A2 (206) and the number of video execution steps is V1 (203). Moreover, the first audio encoder 104 and second picture quality adjustment parameter storage unit 113 are selected as the combination of the audio encoder to be operated and the read-source of the picture quality adjustment parameter to be used by the video encoder, as shown in area 502 in FIG. 5, when the number of audio execution steps is A1 (202) and the number of video execution steps is V2 (207). Moreover, the second audio encoder 111 and second picture quality adjustment parameter storage unit 113 are selected as the combination of the audio encoder to be operated and the read-source of the picture quality adjustment parameter to be used by the video encoder, as shown in area 503 in FIG. 5, when the number of audio execution steps is A2 (206) and the number of video execution steps is V2 (207).

The signal processing mode selection unit 119 selects, according to the signal processing mode selection table shown in FIG. 5, the signal processing mode that operates either the first audio encoder 104 or the second audio encoder 111, and makes either the first picture quality adjustment parameter storage unit 106 or the second picture quality adjustment parameter storage unit 113 effective as the read-source of the picture quality adjustment parameter.

The multiplex unit 107 generates a multiplexed stream (AV stream) by multiplexing the audio stream generated in the audio encoder (the first audio encoder 104 or the second audio encoder 111) with the video stream generated in the video encoder (the first video encoder 105 or the second video encoder 112), and records the multiplexed stream in the recording medium 108.

The recording medium 108 is a writable recording medium such as DVD-RAM.

Next, an operation of the real-time processing apparatus in the present embodiment, configured in the above-mentioned manner, will be described.

FIG. 6 is a flow chart showing an operation of the real-time processing apparatus in the present embodiment. Here, for example, one cycle of a process which is repeated for each audio frame and each video frame is shown.

The audio execution step number notification unit 114 (or the video execution step number notification unit 115) measures the throughput for each frame (number of execution step/frame) of the operating audio encoder (or the video encoder), and notifies it to the audio visual system control unit 117 (step S10).

The execution step number determination unit 118 of the audio visual system control unit 117 compares the threshold values set beforehand with the respective number of execution steps notified from the audio execution step number notification unit 114 and the video execution steps number notification unit 115 according to the power threshold value table shown in FIG. 2, and notifies the result to the signal processing mode selection unit 119 (step S11).

The signal processing mode selection unit 119 selects the signal processing mode corresponding to the comparison result in the execution step number determination unit 118, according to the signal processing mode selection table shown in FIG. 3 to FIG. 5 (step S12).

The audio visual system control unit 117 controls each component according to the signal processing mode selected by the signal processing mode selection unit 119 so that each component 102 to 107 and 109 to 113 operate (or do not operate) (step S13). As a result, the signal processing according to the newly selected the signal processing mode is executed in the following audio frame (or video frame).

As mentioned above, according to the real-time processing apparatus in the present embodiment, the control, which measures the number of execution steps (throughput) in the audio encoder and the video encoder, and changes the signal processing mode so that the number of execution steps decreases when the number of execution steps is equal to or greater than the constant threshold value, is repeated for each frame. Therefore, power consumption can be controlled by merely adding the simple determination process of comparing execution step numbers, without performing the conventional complex arithmetic processing and requiring a special memory resource.

Although the example of the encoder of the audio and the video signal has been shown in the present embodiment, the present invention can be applied also to the decoder. In that case, it only has to measure the number of execution steps in the decoder, compare the number of execution steps with the threshold value, select the signal processing mode on the basis of the comparison result referring to the signal processing mode selection table, and perform the power saving control corresponding to the selected signal processing mode.

Moreover, although the present embodiment is configured with two kinds, namely, a signal processing unit with small throughput and a signal processing unit with large throughput, as signal processing units such as filters and encoders, it is also possible to have a configuration with three or more kinds with different throughput. In such case, it is sufficient to have plural threshold values for comparing with the number of execution steps, and to provide a signal processing mode selection table for deciding the signal processing mode on the basis of the three or more kinds of processing states obtained from the comparisons with the plural threshold values.

### Second Embodiment

Next, a real-time processing apparatus according to the second embodiment of the present invention will be described.

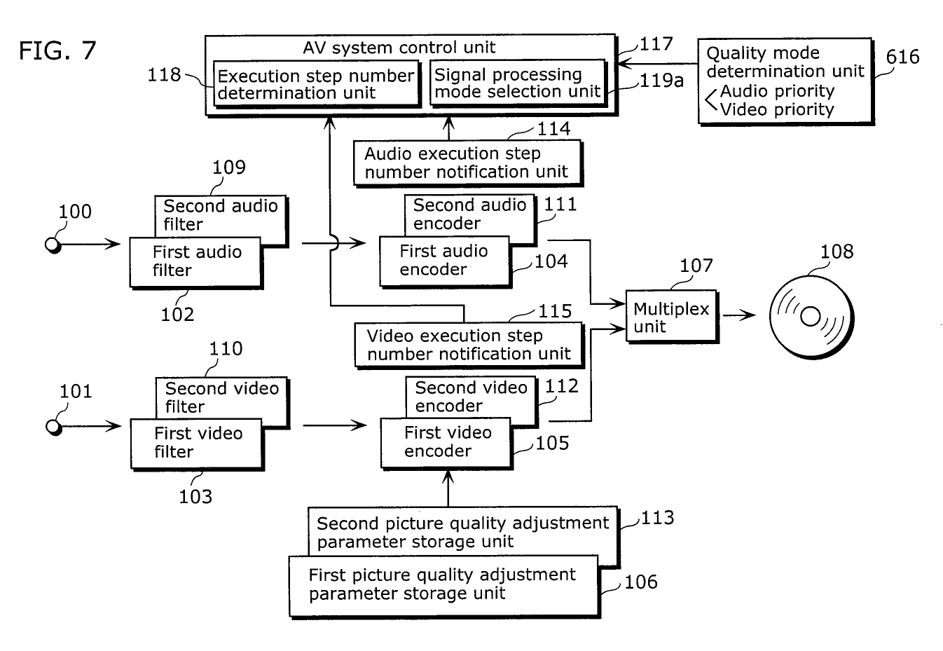

FIG. 7 is a block diagram showing the configuration of the real-time processing apparatus according to the second embodiment of the present invention. The real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and second picture quality adjustment parameter storage unit 113) that can be selectively used, an audio visual system control unit 117 that includes an execution step number determination unit 118 and a signal processing mode selection unit 119a, a multiplex unit 107, a recording medium 108, and a quality mode determination unit 616.

Comparing with the first embodiment shown in FIG. 1, the real-time processing apparatus is different in terms of the addition of a quality mode determination unit 616, and the contents of the signal processing mode selection table included in the signal processing mode selection unit 119a. Hereafter, the same reference numeral is affixed to a component that is the same as in the first embodiment, and the explanation is omitted.

The quality mode determination unit 616 is a processing unit that decides which between the audio quality and the video quality should be given priority. For example, the quality mode determination unit 616 holds internally a flag that shows either audio priority or video priority, according to the instruction from the user.

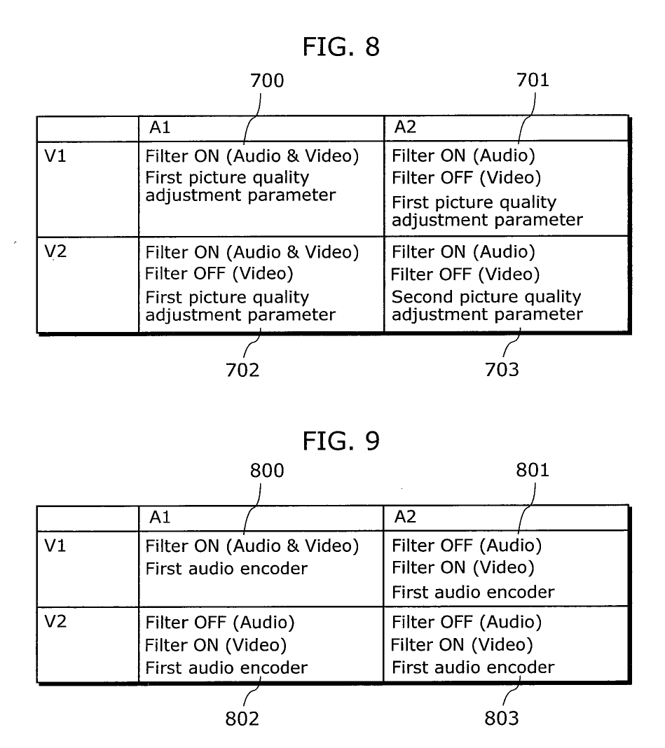

The signal processing mode selection unit 119a is a processing unit that selects the signal processing mode on the basis of the comparison result of the execution step number determination unit 118 and the deciding result of the quality mode determination unit 616, and therefore includes, for that purpose, signal processing mode selection tables shown in FIG. 8 and FIG. 9 as a decision table.

FIG. 8 is a diagram showing the signal processing mode selection table used when giving priority to the quality of audio. This signal processing mode selection table is a decision table for controlling/selecting the filter and the picture quality adjustment parameter so as to decrease the number of execution steps when the number of execution steps is equal to or greater than a constant threshold value, and for controlling/selecting so as that priority is given to audio quality over video quality. The signal processing mode selection table shows the following.

In other words, selection is made so that the filter of audio and video is turned ON, and the first picture quality adjustment parameter storage unit 106 is the read-source of the picture quality adjustment parameter to be used by the video encoder, as shown in area 700 in FIG. 8, when the number of audio execution steps is A1 (202) and the number of video execution steps is V1 (203). Moreover, selection is made so that the filter of audio is turned ON, and the filter of video is turned OFF, and the first picture quality adjustment parameter storage unit 106 is the read-source of the picture quality adjustment parameter to be used by the video encoder, as shown in area 701 in FIG. 8, when the number of audio execution steps is A2 (206) and the number of video execution steps is V1 (203). Moreover, selection is made so that the filter of audio is turned ON, and the filter of video is turned OFF, and the first picture quality adjustment parameter storage unit 106 is the read-source of the picture quality adjustment parameter to be used by the video encoder, as shown in area 702 in FIG. 8, when the number of audio execution steps is A1 (202) and the number of video execution steps is V2 (207). Moreover, selection is made so that the filter of audio is turned ON, and the filter of video is turned OFF, and the second picture quality adjustment parameter storage unit 113 is the read-source of the picture quality adjustment parameter to be used by the video encoder, as shown in area 703 in FIG. 8, when the number of audio execution steps is A2 (206) and the number of video execution steps is V2 (207). Thus, in this signal processing mode selection table, although the audio filter is always turned ON, since the video filter is turned OFF according to the mode, audio is given priority over video.

FIG. 9 is a diagram showing a signal processing mode selection table used when giving priority to the quality of the video. This signal processing mode selection table is a decision table for controlling/selecting the filter and the audio encoder so as to decrease the number of execution steps when the number of execution steps is equal to or greater than a constant threshold value, and for controlling/selecting so that priority is given to video quality over audio quality. This signal processing mode selection table shows the following.

In other words, selection is made so that the filter of audio and video is turned ON, and the first audio encoder 104 is the audio encoder to be operated, as shown in area 800 in FIG. 9, when the number of audio execution steps is A1 (202) and the number of video execution steps is V1 (203). Moreover, selection is made so that the filter of audio is turned OFF, the filter of video is turned ON, and the first audio encoder 104 is the audio encoder to be operated, as shown in area 801 in FIG. 9, when the number of audio execution steps is A2 (206) and the number of video execution steps is V1 (203). Moreover, selection is made so that the filter of audio is turned OFF, the filter of video is turned ON, and the first audio encoder 104 is the audio encoder to be operated, as shown in area 802 in FIG. 9, when the number of audio execution steps is A1 (202) and the number of video execution steps is V2 (207). Moreover, selection is made so that the filter of audio is turned OFF, the filter of video is turned ON, and the second audio encoder 111 is the audio encoder to be operated, as shown in area 803 in FIG. 9, when the number of audio execution steps is A2 (206) and the number of video execution steps is V2 (207). Thus, in this signal processing mode selection table, although the video filter is always turned ON, since the audio filter is turned OFF according to the mode, video is given priority over audio.

When it is decided by the quality mode determination unit 616 that priority should be given to the audio quality, the signal processing mode selection unit 119a selects the signal processing mode according to the signal processing mode selection table shown in FIG. 8. On the other hand, when it is decided by the quality mode determination unit 616 that priority should be given to video quality, the signal processing mode selection unit 119a selects the signal processing mode according to the signal processing mode selection table shown in FIG. 9.

The operation mode (ON/OFF etc.) for a component (for example, the video encoder) that is not stipulated in the signal processing mode selection tables in FIG. 8 and FIG. 9 is decided according to a predetermined default setting or a specification by the user.

Next, an operation of the real-time processing apparatus in the present embodiment, configured in the above-mentioned manner, will be described.

The real-time processing apparatus in the present embodiment selects the signal processing mode of each frame as well as the first embodiment according to the flow chart shown in FIG. 6, and executes the signal processing in the selected signal processing mode. However, in the present embodiment, before this processing, a processing to select the using signal processing mode selection table from the table of two varieties (FIG. 8 and FIG. 9) is added.

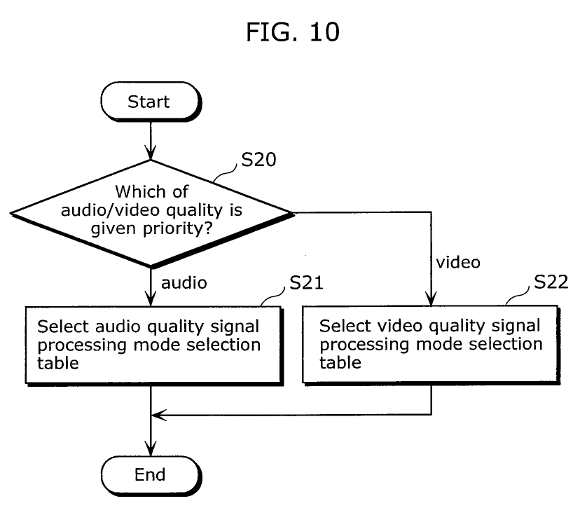

FIG. 10 is a flow chart showing an operation concerning the selection of the signal processing mode selection table from among the operation of the real-time processing apparatus in the present embodiment.

The quality mode determination unit 616 decides which between the audio quality and the video quality should be given priority (step S20). For example, the quality mode determination unit 616 acquires an instruction from the user before the signal processing, and stores the flag that shows either of audio priority/video priority in an internal memory according to the instruction.

The signal processing mode selection unit 119a determines, by referring to the flag stored in the quality mode determination unit 616, which between audio or video quality should be given priority according to the decision by the quality mode determination unit 616. As a result of the determination, the signal processing mode is selected according to the signal processing mode selection table shown in FIG. 8 when it is decided that priority should be given to the quality of audio (step S21). On the other hand, as a result of the determination, the signal processing mode is selected according to the signal processing mode selection table shown in FIG. 9 when it is decided that priority should be given to the quality of the video (step S22). As a result, the signal is encoded with priority being given to the quality of audio or the quality of video according to the decision by the quality mode determination unit 616.

As mentioned above, according to the real-time processing apparatus in the present embodiment, the power consumption is controlled by merely adding the simple determination processing of comparing the numbers of execution steps, and the signal processing is executed with priority being given to the quality of either audio or video. As a result, the signal processing is executed with the quality of audio/video that the user expects, and the power consumption is reduced.

In the present embodiment, two kinds of signal processing mode selection tables which give priority to the quality of either audio or the video are provided. However, in addition this, a third signal processing mode selection table (for example, the signal processing mode selection table in the first embodiment) that does not give priority to either the audio or the video (table that does not apply superiority or inferiority to quality of audio and quality of video) may also be provided.

### Third Embodiment

Next, a real-time processing apparatus according to the third embodiment of the present invention will be described.

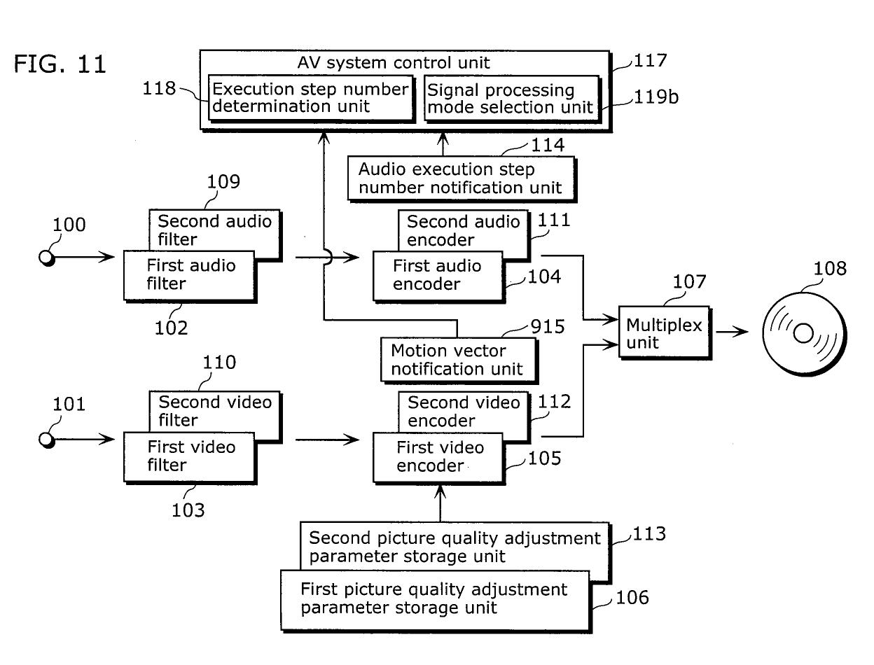

FIG. 11 is a block diagram showing a configuration of the real-time processing apparatus according to the third embodiment of the present invention. This real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a motion vector notification unit 915, two picture quality adjustment parameter storage units (a first picture quality adjustment parameter storage unit 106 and second picture quality adjustment parameter storage unit 113) that can be selectively used, an audio visual system control unit 117 that includes a motion vector determination unit 918 and a signal processing mode selection unit 119b, a multiplex unit 107, and a recording medium 108.

Comparing with embodiment 1 shown in FIG. 1, the real-time processing apparatus is different in terms of the addition of a motion vector determination unit 918 in place of the video execution step number notification unit 115, and that the inclusion of the motion vector notification unit 915 in place of the execution step number determination unit 118, and the contents the signal processing mode selection table included in the signal processing mode selection unit 119b. Hereafter, the same reference numeral is affixed to a component that is the same as in the first embodiment, and the explanation is omitted.

Motion vector notification unit 915 notifies the motion vector detected in the operating video encoder (the first video encoder 105 or the second video encoder 112) to the audio visual system control unit 117. More specifically, the specification of the largest motion vector detected in each frame as the parameter that shows the throughput for the video signal, and the notification of such motion vector (here, the size of the motion vector) to the audio visual system control unit 117 is repeated for each frame.

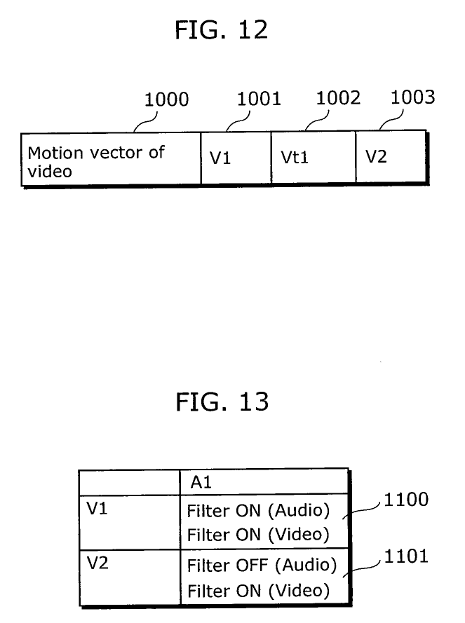

The motion vector determination unit 918 compares the threshold values set beforehand with the motion the number of execution steps notified from audio execution steps number notification unit 114 and the motion vector notified from the vector notification unit 915. With respect to the number of execution steps notified from the audio execution steps number notification unit 114, the motion vector determination unit 918 determines the state A1 (202) or the state A2 (206) by using the power threshold value table shown in FIG. 2, as in the first embodiment. On the other hand, with respect to the motion vector notified from the motion vector notification unit 915, the motion vector (here, size of the motion vector) 1000 notified from the motion vector notification unit 915 and a motion vector threshold value Vt1 (1002) are compared using the power threshold value table shown in FIG. 12, and the result is notified to the signal processing mode selection unit 119b. Note that, hereafter, the case where the motion vector 1000 is less than the motion vector threshold value Vt1 (1002) is called “V1 (1001)”, and the case where the motion vector 1000 is equal to or greater than the motion vector threshold value Vt1 (1002) is called “V2 (1003)”.

The signal processing mode selection unit 119b is a processing unit that selects the signal processing mode on the basis of the comparison result in the motion vector determination unit 918, and includes a signal processing mode selection table shown in FIG. 13 as a decision table for such purpose.

FIG. 13 is a diagram showing the signal processing mode selection table for the filter control. This signal processing mode selection table is a decision table for controlling the filter so as to decrease the signal processing (here, the filter processing) on the video signal when the motion vector notified from the motion vector notification unit 915 is equal to or greater than a constant threshold value. The signal processing mode selection table shows the following. In other words, the filter of audio and video is turned ON, as shown in area 1100 in FIG. 13, when the number of audio execution steps is A1 (202) and the motion vector is V1 (1001). Moreover, the filter of audio is turned OFF and the filter of video is turned ON, as shown in area 1101 in FIG. 13, when the number of audio execution steps is A1 (202) and the motion vector is V2 (1003).

The signal processing mode selection unit 119b selects, according to the signal processing mode selection table shown in FIG. 13, the signal processing mode which turns the audio filter selected from among the first audio filter 102 and second audio filter 109 to ON or OFF, and turns the video filter selected from among the first video filter 103 and the second video filter 110 to ON or OFF.

In addition, the operation mode (ON/OFF etc.) for a component (for example, the video encoder) and an operating state (for example, state A2) that are not stipulated in the signal processing mode selection table in FIG. 13 are decided according to a predetermined default setting or a specification by the user.

Next, the operation of the real-time processing apparatus in the present embodiment, configured in the above-mentioned manner, will be described. The real-time processing apparatus in the present embodiment basically operates in the same manner as that in the first embodiment. However, with respect to the video signal, the determination of throughput and the signal processing mode selection table to be used are different.

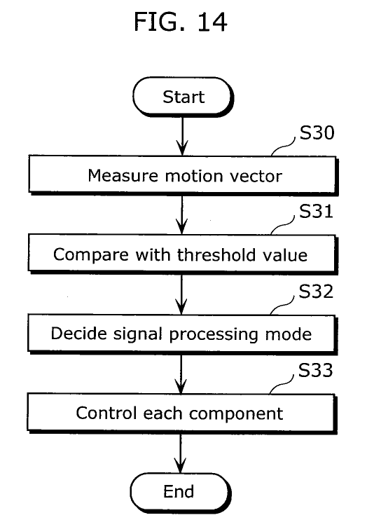

FIG. 14 is a flow chart showing the operation of the real-time processing apparatus in the present embodiment. Here, the processing of the video signal, in other words, one cycle of the processing which is repeated for each video frame is shown.

The motion vector notification unit 915 specifies, for each frame, the motion vector for which size is greatest, from among the motion vectors detected with the operating video encoder, and notifies this to the audio visual system control unit 117 (step S30).

The motion vector determination unit 918 of the audio visual system control unit 117 compares the threshold values set beforehand with the motion vector notified from the motion vector notification unit 915 according to the power threshold value table shown in FIG. 12, and notifies the result to the signal processing mode selection unit 119b (step S31).

The signal processing mode selection unit 119b selects the signal processing mode corresponding to the comparison result by the motion vector determination unit 918, according to the signal processing mode selection table shown in FIG. 13 (step S32).

The audio visual system control unit 117 controls each component so that each of the components 102 to 107 and 109 to 113 operate/do not operate, according to the signal processing mode selected by the signal processing mode selection unit 119b (step S33). As a result, the signal processing according to the newly selected signal processing mode is executed in the following video frame.

As mentioned above, according to the real-time processing apparatus in the present embodiment, the control, which measures the of the motion vector detected by the video encoder, and changes the signal processing mode so that the throughput on the video signal decreases when the maximum value is equal to or greater than the constant threshold value, is repeated for each frame. Therefore, power consumption can be controlled by merely adding the simple determination process of comparing the maximum value with the threshold value, without performing the conventional complex arithmetic processing and requiring a special memory resource.

Although the motion vector is used as the information that shows the throughput in the video encoder in place of the number of execution steps in the present embodiment, both the number of execution steps and the motion vector may be used. At that time, it is sufficient to provide a signal processing mode selection table for deciding the signal processing mode according the comparison result of comparing the number of execution steps and each motion vector with the threshold value.

### Fourth Embodiment

Next, a real-time processing apparatus according to the fourth embodiment of the present invention will be described.

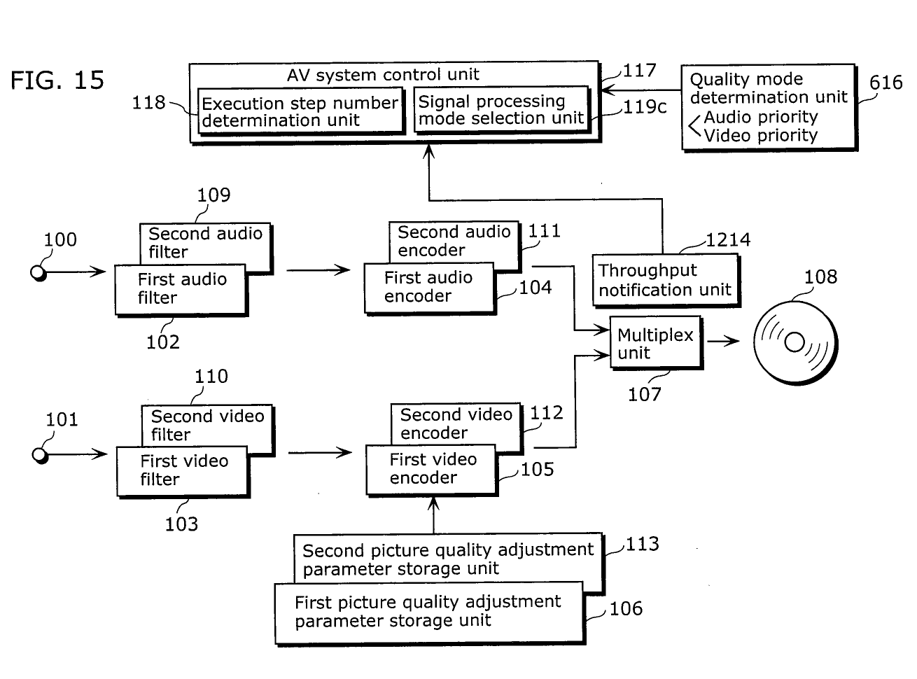

FIG. 15 is a block diagram showing a configuration of the real-time processing apparatus according to the fourth embodiment of the present invention. This real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, a video input terminal 101, two video filters (a first video filter 103 and a second video filter 110) that can be selectively used, two video encoders (a first video encoder 105 and a second video encoder 112) that can be selectively used, two picture quality adjustment parameter storage units (a first picture quality adjustment parameter storage unit 106 and second picture quality adjustment parameter storage unit 113) that can be selectively used, an audio visual system control unit 117 that includes a throughput determination unit 1217 and a signal processing mode selection unit 119c, a multiplex unit 107, a throughput notification unit 1214, a recording medium 108 and a quality mode determination unit 616.

Comparing with the first embodiment shown in FIG. 1, the real-time processing apparatus is different in terms of the inclusion of a throughput notification unit 1214 in place of the audio execution step number notification unit 114 and the video execution step number notification unit 115, the inclusion of a throughput determination unit 1217 in place of the execution step number determination unit 118, the addition of a quality mode determination unit 616 similar to that in the second embodiment, and the contents of the signal processing mode selection table included in the signal processing mode selection unit 119c. Hereafter, the same reference numeral is affixed to a component that is the same as in the first embodiment, and the explanation is omitted.

The throughput notification unit 1214 measures the throughput (here, bit rate of the multiplex stream generated by the multiplex unit 107) in the signal processing of this real-time processing apparatus, and notifies it to the audio visual system control unit 117 as throughput information.

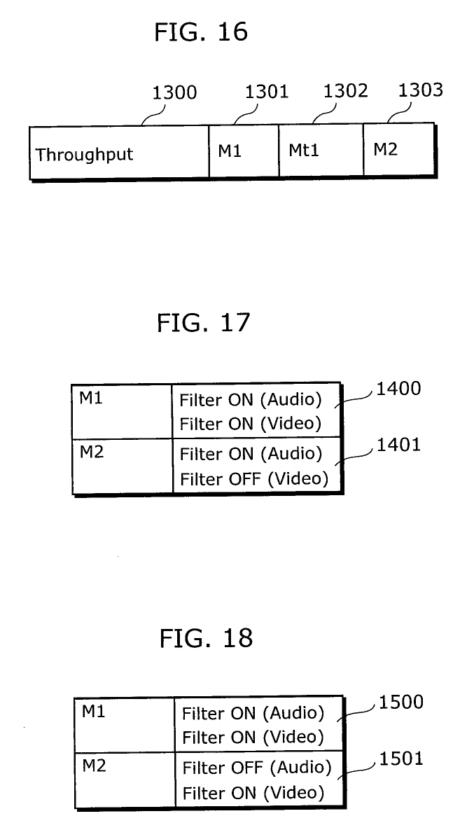

The throughput determination unit 1217 compares a threshold value set beforehand with the throughput information notified from throughput notification unit 1214. More specifically, the throughput 1300 and the throughput threshold value Mt1 (1302) notified from the throughput notification unit 1214 are compared using the power threshold value table shown in FIG. 16, and the result is notified to the signal processing mode selection unit 119c. Note that, hereafter, the case where the throughput 1300 is less than the throughput threshold value Mt1 (1302) is called “M1 (1301)”, and the case where the throughput 1300 is equal to or greater than the throughput threshold value Mt1 (1302) is called “M2 (1303)”.

The signal processing mode selection unit 119c is a processing unit that selects the signal processing mode on the basis of the comparison result by the throughput determination unit 1217 and the deciding result by the quality mode determination unit 616, and includes the signal processing mode selection tables shown in FIG. 17 and FIG. 18 as a decision table for that.

FIG. 17 is a diagram showing the signal processing mode selection table used when giving the priority to the quality of audio. This signal processing mode selection table is a decision table for controlling the filter so as to decrease the number of execution steps in the signal processing when the throughput notified from the throughput notification unit 1214 is equal to or greater than a constant threshold value, and for controlling so as that audio quality is given priority over video quality. The signal processing mode selection table shows the following.

In other words, the filter of audio and video is turned ON, as shown in area 1400 in FIG. 17, when the throughput notified from the throughput notification unit 1214 is M1 (1301). Moreover, the filter of audio is turned ON and the filter of video is turned OFF, as shown in area 1401 in FIG. 17, when the throughput notified from the throughput notification unit 1214 is M2 (1303). Thus, in this signal processing mode selection table, although the audio filter is always turned ON, since the video filter is turned OFF according to the mode, audio is given priority over video.

FIG. 18 is a diagram showing the signal processing mode selection table used when giving the priority to the quality of video. This signal processing mode selection table is a decision table for controlling the filter so as to decrease the number of execution steps in the signal processing when the throughput notified from the throughput notification unit 1214 is equal to or greater than a constant threshold value, and for controlling so that video quality is given priority over audio quality. The signal processing mode selection table shows the following.

In other words, the filter of audio and video is turned ON, as shown in area 1500 in FIG. 18, when the throughput notified from the throughput notification unit 1214 is M1 (1301). Moreover, the filter of audio is turned OFF and the filter of video is turned ON, as shown in area 1501 in FIG. 18, when the throughput notified from the throughput notification unit 1214 is M2 (1303). Thus, in this signal processing mode selection table, although the video filter is always turned ON, since the audio filter is turned OFF according to the mode, video is given priority over audio.

When it is decided by the quality mode determination unit 616 that priority should be given to the quality of audio, the signal processing mode selection unit 119c selects the signal processing mode according to the signal processing mode selection table shown in FIG. 17. On the other hand, when it is decided by the quality mode determination unit 616 that priority should be given to the quality of video, the signal processing mode selection unit 119c selects the signal processing mode according to the signal processing mode selection table shown in FIG. 18.

In addition, the operation mode (ON/OFF etc.) for a component (for example, video encoder) that is not stipulated in the signal processing mode selection tables in FIG. 17 and FIG. 18 is decided according to a predetermined default setting or a specification by the user.

Next, the operation of the real-time processing apparatus in the present embodiment, configured in the above-mentioned manner, will be described.

The operation for selecting one from two signal processing mode selection tables is the same as in the second embodiment. That is, the signal processing mode selection unit 119c determines, by referring to the flag stored in the quality mode determination unit 616, which between audio or video quality should be given priority according to the decision by the quality mode determination unit 616. As a result of the determination, the signal processing mode is selected according to the signal processing mode selection table shown in FIG. 17 when decided that priority should be given to the quality of audio. On the other hand, as a result of the determination, the signal processing mode is selected according to the signal processing mode selection table shown in FIG. 18 when it is decided that priority should be given to the quality of the video.

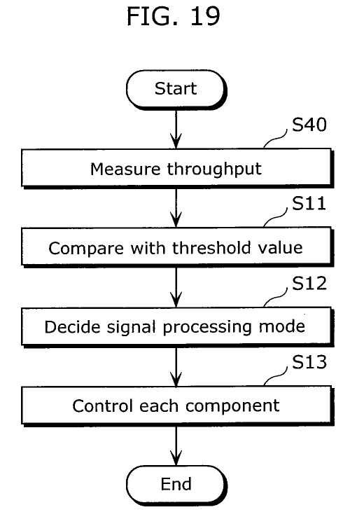

Moreover, the selection and the control of the signal processing mode using the selected signal processing mode selection table, as shown in the flow chart of FIG. 19, is basically the same as in the first embodiment. However, the point that throughput notification unit 1214 measures throughput in place of the measurement of the number of execution steps by the audio execution step number notification unit 114 and the video execution step number notification unit 115 is different (S40).

As mentioned above, according to the real-time processing apparatus in the present embodiment, the power consumption is controlled by merely adding the simple determination processing of comparing the throughput in the signal processing, and the signal processing is executed with priority being given to the quality of either audio or video. As a result, the signal processing is executed with the quality of audio/video that the user expects, and the power consumption is reduced.

In addition, although the turning ON/OFF of the filter is described in the signal processing mode selection table in the present embodiment, the selection/turning ON/OFF of the encoder and the picture quality adjustment parameter may also be described as shown in FIG. 4 and FIG. 5.

Note that although, in the present embodiment, the signal processing mode is selected on the basis of the throughput of the signal processing in multiplex unit 107, it is also possible to have a configuration in which the number of audio execution steps and the number of video execution steps are measured in addition to the throughput, and the signal processing mode is selected on the basis of those three information (the throughput, the number of audio execution steps and the number of video execution steps).

### Fifth Embodiment

Next, a real-time processing apparatus according to the fifth embodiment of the present invention will be described.

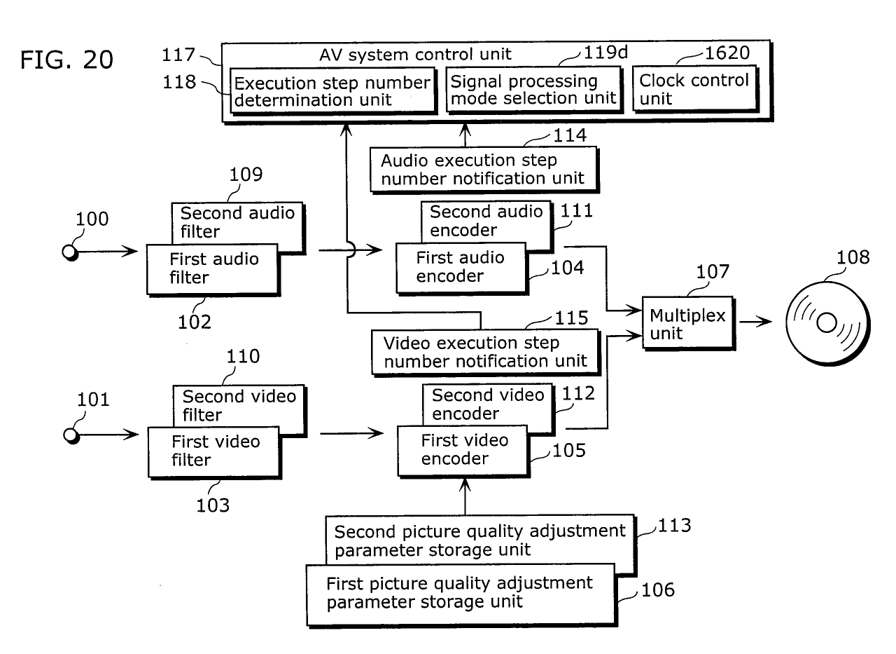

FIG. 20 is a block diagram showing the configuration of the real-time processing apparatus according to the fifth embodiment of the present invention. This real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and second picture quality adjustment parameter storage unit 113) that can be selectively used, an audio visual system control unit 117 that includes an execution step number determination unit 118 and a signal processing mode selection unit 119d and a clock control unit 1620, a multiplex unit 107, and a recording medium 108.

Comparing with the first embodiment shown in FIG. 1, the real-time processing apparatus is different in terms of the addition of a clock control unit 1620 in the audio visual system control unit 117, and the contents of the signal processing mode selection table included in the signal processing mode selection unit 119d. Hereafter, the same reference numeral is affixed to a component that is the same as in the first embodiment, and the explanation is

17. A real-time processing method of processing an input signal in real time, said method comprising steps of:

performing a first signal processing in real time on the input signal;

performing a second signal processing with throughput smaller than throughput in said performing of the first signal processing, in real time on the input signal;

measuring a step number indicating a level of the throughput in said performing of the first signal processing or said performing of the second signal processing which is executed; and

controlling so that said performing of the first signal processing is executed when the measured step number is less then a threshold value provided beforehand, and said performing of the second signal processing is executed when the measured step number is equal to or greater than the threshold value.

18. A program for use in a real-time processing apparatus which processes an input signal in real time, said program causing a computer to execute the steps included in the real-time processing method according to claim 17.

omitted.

The clock control unit 1620 is a processing unit which changes the frequency of the clock signal (hereafter referred to simply as “clock”) supplied to each component (the audio encoder and the video encoder, etc.) of the real-time processing apparatus. For example, a clock generation circuit (not shown) that includes a frequency divider is provided in the real-time processing apparatus, and the clock control unit 1620 raises and lowers the frequency of the clock supplied to each component by changing the dividing ratio of the frequency divider.

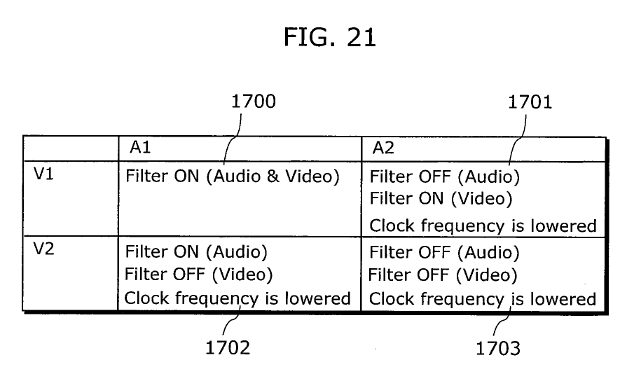

The signal processing mode selection unit 119d is a processing unit that selects the signal processing mode on the basis of the comparison result by the execution step number determination unit 118, and includes a signal processing mode selection table shown in FIG. 21 as a decision table for that.

FIG. 21 is a diagram showing a signal processing mode selection table to control the filter and the clock. This signal processing mode selection table is a decision table to control so as to decrease the number of execution steps and lowering the clock frequency when the number of execution steps is equal to or greater than a constant threshold value. This signal processing mode selection table shows the following. In other words, the filter of audio and video is turned ON, as shown in area 1700 in FIG. 21, when the number of audio execution steps is A1 (202) and the number of video execution steps is V1 (203). Moreover, the filter of audio is turned OFF, the filter of video is turned ON, and the clock frequency is lowered, as shown in area 1701 in FIG. 21, when the number of audio execution steps is A2 (206) and the number of video execution steps is V1 (203). Moreover, the filter of audio is turned ON, the filter of video is turned OFF, and the clock frequency is lowered, as shown in area 1702 in FIG. 21, when the number of audio execution steps is A1 (202) and the number of video execution steps is V2 (207). Moreover, the filter of audio is turned OFF, the filter of video is turned OFF, and the clock frequency is lowered, as shown in area 1703 in FIG. 21, when the number of audio execution steps is A2 (206) and the number of video execution steps is V2 (207).

The signal processing mode selection unit 119d turns the audio filter selected from among the first audio filter 102 and the second audio filter 109 to ON or OFF, and turns the video filter selected from among the first video filter 103 and the second video filter 110 to ON or OFF, according to the signal processing mode selection table shown in FIG. 21. The signal processing mode selection unit 119d further selects the signal processing mode so that the frequency of the clock supplied to each component is set to a normal value or to the low value by the clock control unit 1620.

The operation mode (ON/OFF etc.) for a component (for example, the video encoder) that is not stipulated in the signal processing mode selection table in FIG. 21, is decided according to a predetermined default setting or a specification by the user.

The operation of the real-time processing apparatus in the present embodiment, configured in the above-mentioned manner, is basically the same as in the first embodiment. However, in the present embodiment, the frequency of the clock supplied to each component is also controlled through the control according to the selected signal processing mode (step S13).

As mentioned above, according to the real-time processing apparatus in the present embodiment, aside from executing the control to turn each component to ON/OFF, control for changing the clock frequency is also is executed on the basis of throughput, and thus, the power consumption is further reduced.

In addition, although the turning ON/OFF of the filter and the clock frequency are described in the signal processing mode selection table in the present embodiment, the selection/turning ON/OFF of the encoder and the picture quality adjustment parameter may also be described as shown in FIG. 4 and FIG. 5.

### Sixth Embodiment

Next, a real-time processing apparatus according to the sixth embodiment of the present invention will be described.

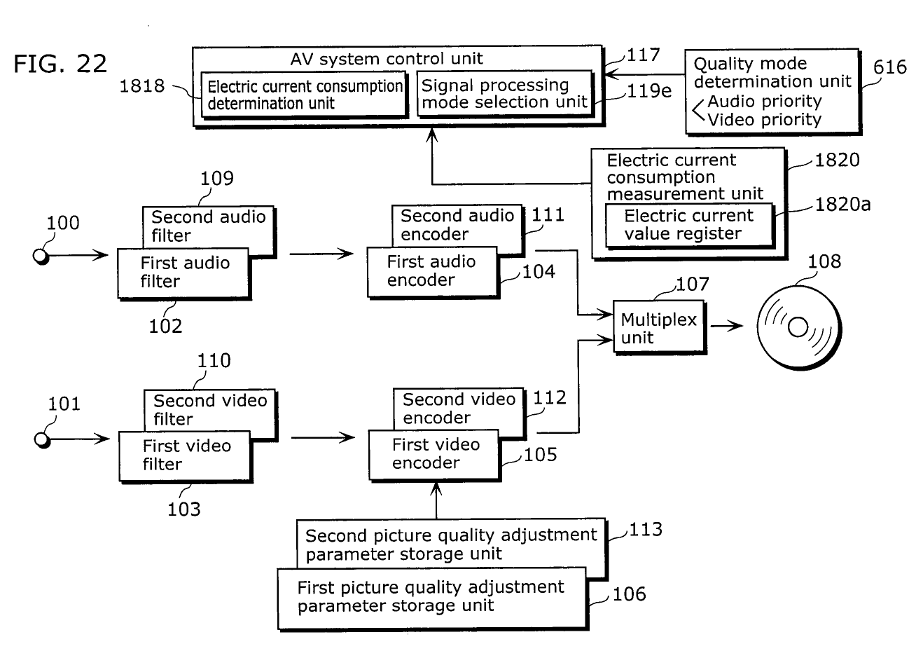

FIG. 22 is a block diagram showing a configuration of the real-time processing apparatus according to the sixth embodiment of the present invention. The real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and second picture quality adjustment parameter storage unit 113) that can be selectively used, an audio visual system control unit 117 that includes a electric current consumption determination unit 1818 and a signal processing mode selection unit 119e, a multiplex unit 107, a electric current consumption measurement unit 1820, a recording medium 108, and a quality mode determination unit 616.

Comparing with the fourth embodiment shown in FIG. 15, the real-time processing apparatus is different in terms of the inclusion of an electric current consumption measurement unit 1820 in place of the throughput notification unit 1214, the inclusion of the electric current consumption determination unit 1818 in place of the throughput determination unit 1217, and the contents of the signal processing mode selection table included in the signal processing mode selection unit 119e. Hereafter, the same reference numeral is affixed to a component that is the same as in the fourth embodiment, and the explanation is omitted.

The electric current consumption measurement unit 1820 is a processing unit that measures the electric current consumption in this real-time processing apparatus regularly (for example, each 1 ms), and stores it in an internal electric current value register 1820a while updating the measurement.

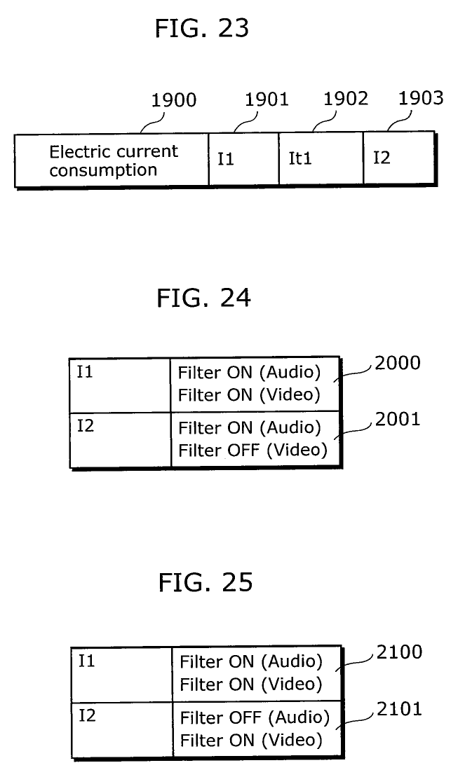

The electric current consumption determination unit 1818 reads the electric current value held in the electric current value register 1820a of the electric current consumption measurement unit 1820 regularly (for example, each 3 ms), calculates the average of each frame (for example, 33 ms), and compares the threshold values set beforehand with the electric current consumption that is the calculated average value. More specifically, the electric current consumption 1900 which is averaged for each frame and the electric current consumption threshold value It1 (1902) are compared by using the power threshold value table shown in FIG. 23, and the result is notified to the signal processing mode selection unit 119e. Note that, hereafter, the case where the electric current consumption 1900 is less than the electric current consumption threshold value It1 (1902) is called “I1 (1901)”. The case where the electric current consumption 1900 is equal to or greater than the electric current consumption threshold value It1 (1902) is called “I2 (1903)”.

The signal processing mode selection unit 119e is a processing unit that selects the signal processing mode on the basis of the comparison result by the electric current consumption determination unit 1818 and the deciding result by the quality mode determination unit 616, and includes the signal processing mode selection table shown in FIG. 24 and FIG. 25 as a decision table for that.

FIG. 24 is a diagram showing the signal processing mode selection table used when giving the priority to the quality of audio. The signal processing mode selection table is a decision table for controlling the filter so as to decrease the number of execution steps in the signal processing when the average electric current consumption calculated by the electric current consumption determination unit 1818 is equal to or greater than a constant threshold value, and for controlling so that audio quality is given priority over video quality. The signal processing mode selection table shows the following.

In other words, the filter of audio and video is turned ON, as shown in area 2000 in FIG. 24, when the average electric current consumption calculated by the electric current consumption determination unit 1818 is I1 (1901). Moreover, the filter of audio is turned ON and the filter of video is turned OFF, as shown in area 2001 in FIG. 24, when the average electric current consumption calculated by the electric current consumption determination unit 1818 is I2 (1903). Thus, in this signal processing mode selection table, although the audio filter is always turned ON, since the video filter is turned OFF according to the mode, audio is given priority over video.

FIG. 25 is a diagram showing the signal processing mode selection table used when giving the priority to the quality of video. The signal processing mode selection table is a decision table for controlling the filter so as to decrease the number of execution steps in the signal processing when the average electric current consumption calculated by the electric current consumption determination unit 1818 is equal to or greater than a constant threshold value, and for controlling so that video quality is given priority over audio quality. The signal processing mode selection table shows the following.

In other words, the filter of audio and video is turned ON, as shown in area 2100 in FIG. 25, when the average electric current consumption calculated by the electric current consumption determination unit 1818 is I1 (1901). Moreover, the filter of audio is turned OFF and the filter of video is turned ON, as shown in area 2101 in FIG. 25, when the average electric current consumption calculated by the electric current consumption determination unit 1818 is I2 (1903). Thus, in this signal processing mode selection table, although the video filter is always turned ON, since the audio filter is turned OFF according to the mode, video is given priority over audio.

When it is decided by the quality mode determination unit 616 that priority should be given to the quality of audio, the signal processing mode selection unit 119e selects the signal processing mode according to the signal processing mode selection table shown in FIG. 24. On the other hand, when it is decided by the quality mode determination unit 616 that priority should be given to the quality of video, the signal processing mode selection unit 119e selects the signal processing mode according to the signal processing mode selection table shown in FIG. 25.

In addition, the operation mode (ON/OFF etc.) for a component (for example, video encoder) that is not stipulated in the signal processing mode selection tables in FIG. 24 and FIG. 25 is decided according to a predetermined default setting or a specification by the user.

An operation of the real-time processing apparatus in the present embodiment, configured in the above-mentioned manner, is basically the same as in the fourth embodiment. However, in the present embodiment, the signal processing mode is decided depending on the electric current consumption instead of the throughput.

As mentioned above, according to the real-time processing apparatus in the present embodiment, the power consumption is controlled by merely adding the simple determination processing of comparing the electric current consumption and the threshold value, and the signal processing is executed with priority being given to the quality of either audio or video. As a result, the signal processing is executed with the quality of audio/video that the user expects, and the power consumption is reduced.

In addition, although the turning ON/OFF of the filter is described in the signal processing mode selection table in the present embodiment, the selection/turning ON/OFF of the encoder and the picture quality adjustment parameter may also be described, as shown in FIG. 4 and FIG. 5.

Furthermore, although the signal processing mode is selected in the present embodiment on the basis of the electric current consumption measured by electric current consumption measurement unit 1820, it is also possible to have a configuration in which the number of audio execution steps and the number of video execution steps are measured in addition to throughput, and the signal processing mode is selected on the basis of those three information (the electric current consumption, the number of audio execution steps, and the number of video execution steps).

### Seventh Embodiment

Next, the real-time processing apparatus according to the seventh embodiment of the present invention will be described.

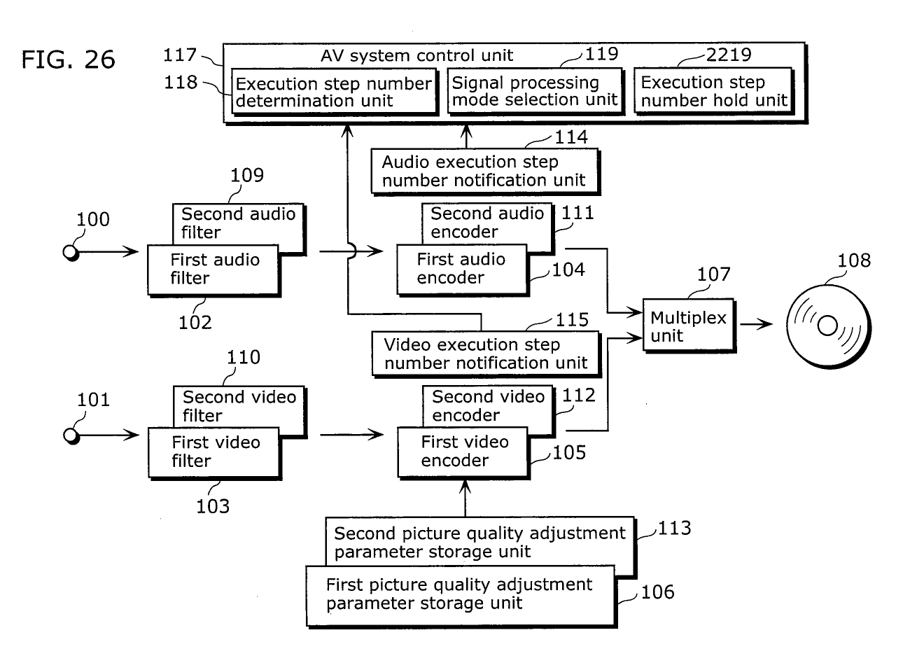

FIG. 26 is a block diagram showing the configuration of the real-time processing apparatus according to the seventh embodiment of the present invention. The real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution steps number notification unit 114, a video input terminal 101, two video filters (a first video filter 103 and a second video filter 110) that can be selectively used, two video encoders (a first video encoder 105 and a second video encoder 112) that can be selectively used, a video execution step number notification units 115, two picture quality adjustment parameter storage units (a first picture quality adjustment parameter storage unit 106 and second picture quality adjustment parameter storage unit 113) that can be selectively used, an audio visual system control unit 117 that includes an execution step number determination unit 118 and a signal processing mode selection unit 119 and an execution step number hold unit 2219, a multiplex unit 107, and a recording medium 108.

Comparing with the first embodiment shown in FIG. 1, the real-time processing apparatus is different in terms of the addition of an execution step number hold unit 2219. Hereafter, the same reference numeral is affixed to a component that is the same as in the first embodiment, and the explanation is omitted.

The execution step number hold unit 2219 is a non-volatile memory etc. that holds while accumulating the number of execution steps notified from the audio execution step number notification unit 114 and the video execution steps number notification unit 115 into an internal execution step number hold table. In addition, the determination result of the execution step number determination unit 118 may be held in place of the number of execution steps.

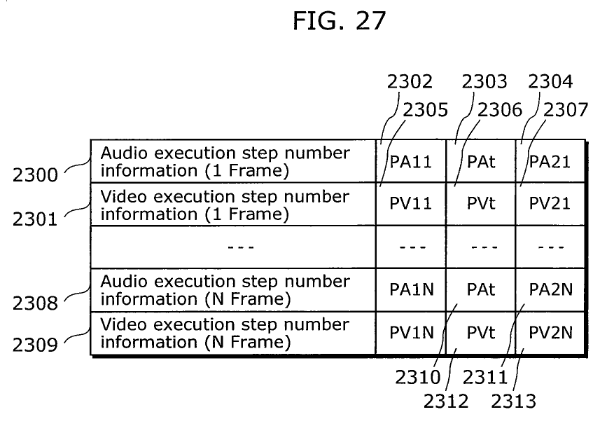

FIG. 27 is a diagram showing the structure of an execution step number hold table included in the execution step number hold unit 2219. This execution step number hold table is a management table that can hold the number of execution steps of audio and video in each frame or/and in addition, can hold the determination result by the execution step number determination unit 118.

The number of execution steps of each frames of audio and video notified from the audio execution step number notification unit 114 and the video execution steps number notification unit 115 are recorded in the execution step number hold table. For example, as shown in the left-hand column in FIG. 27, the number of execution steps are recorded in the execution step number hold table as the audio execution steps number information of the 1^{st} frame 2300, video execution steps number information of the 1^{st} frame 2301, . . . , audio execution steps number information of N^{th} frame 2308, and video execution step number information of N^{th} frame 2309.

Moreover, the determination result in the execution step number determination unit 118 may also be recorded as shown in three columns at the right of FIG. 27. Assuming that the audio execution step number threshold value set beforehand is PAt2303 and the video execution step number threshold value is PVt2306, a value PA11 (2302) is recorded when the audio execution step number information of the 1^{st} frame 2300 is less than the audio execution step number threshold PAt, and a value PA21 (2304) is recorded when the audio execution step number information of the 1^{st} frame 2300 is equal to or greater than the audio execution step number threshold PAt. Similarly, a value PV11 (2305) is recorded when the video execution step number information of the 1^{st} frame 2301 is less than the video execution step number threshold value PVt, and a value PV21 (2307) is recorded when the video execution step number information of the 1^{st} frame 2301 is equal to or greater than the video execution step number threshold value PVt. Similarly, a value PA1N (2310) is recorded when the audio execution step number information of the N^{th} frame 2308 is less than the audio execution step number threshold value PAt, and a value PA2N (2311) is recorded when the audio execution step number information of the N^{th} frame 2308 is equal to or greater than the audio execution step number threshold value PAt. Similarly, a value PV1N (2312) is recorded when the video execution step number information of the N^{th} frame 2309 is less than the video execution step number threshold value PVt, and a value PV2N (2313) is recorded when the video execution step number information of the N^{th} frame 2309 is equal to or greater than the video execution step number threshold value PVt.

Aside from indicating the per frame throughput during encoding, the number of execution steps or the comparison result of the numbers of execution steps and the threshold value (hereafter the “number of execution steps” and “comparison result for the number of execution steps and the threshold value” is referred to collectively as “number of execution steps etc.”) recorded in this manner, also indicate the throughput during the decoding (reproducing) of the stream generated by such encoding.

Therefore, by referring to the execution step number hold table held to the execution step number hold unit 2219 when the stream recorded in the recording medium 108 is decoded, the throughput during decoding can be known immediately, and can be used to decide the signal processing mode for power reduction, as when encoding. In other words, by referring to the execution step number hold table held to the execution step number hold unit 2219, the audio visual system control unit 117 may decide the signal processing mode during decoding, and control each component, in the same manner as in the encoding.

As mentioned above, according to the real-time processing apparatus in the present embodiment, since the execution step number hold unit 2219 is added to the first embodiment, and the number of execution steps etc. is recorded in the execution step number hold table, the signal processing mode for reducing power consumption can be decided while referring to the execution step number hold table in the reproduction of the stream recorded in the recording medium 108. As a result, power consumption can be reduced, not only during recording, but also during reproduction.

In addition, although the number of execution steps etc. in the audio encoder and the video encoder are held in the present embodiment, in place of or in addition to this, when the throughput in the multiplex unit 107 and the electric current consumption of the real-time processing apparatus are measured, the measured throughput and electric current consumption value may be held. As a result, since the processing load in the real-time processing apparatus is understood in more detail, a more exact power saving control becomes possible.

### Eighth Embodiment

Next, a real-time processing apparatus according to the eighth embodiment of the present invention will be described.

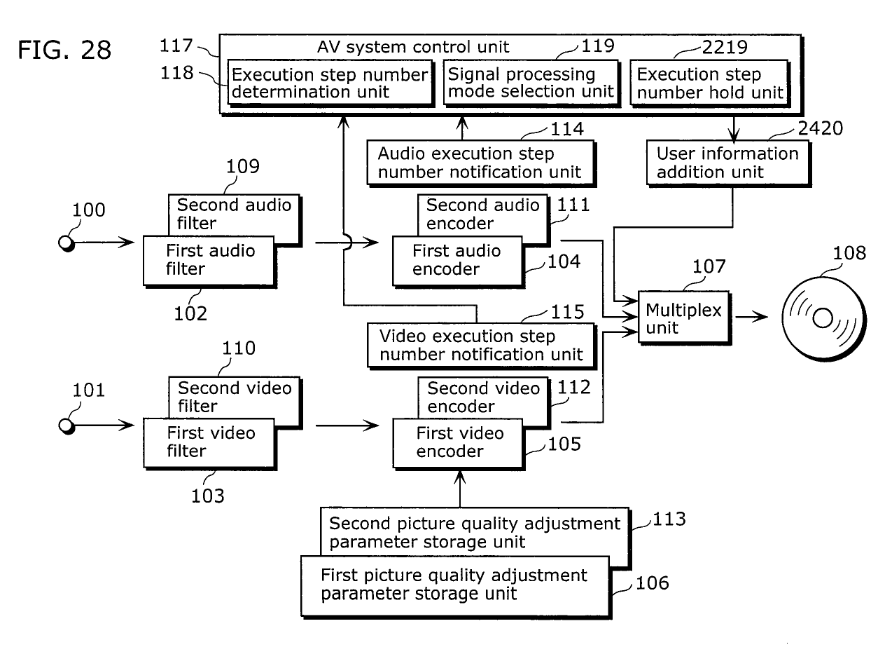

FIG. 28 is a block diagram showing the configuration of the real-time processing apparatus according to the eighth embodiment of the present invention. The real-time processing apparatus is a recorder that, in real time, encodes and multiplexes inputted audio signal and video signal, and records it in a recording medium 108. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution steps number notification unit 114, a video input terminal 101, two video filters (a first video filter 103 and a second video filter 110) that can be selectively used, two video encoders (a first video encoder 105 and a second video encoder 112) that can be selectively used, a video execution step number notification units 115, two picture quality adjustment parameter storage units (a first picture quality adjustment parameter storage unit 106 and second picture quality adjustment parameter storage unit 113) that can be selectively used, an audio visual system control unit 117 that includes an execution step number determination unit 118 and a signal processing mode selection unit 119 and an execution step number hold unit 2219, a multiplex unit 107, a recording medium 108 and an user information addition unit 2420.

Comparing with the seventh embodiment shown in FIG. 26, the real-time processing apparatus is different in terms of the addition of a user information addition unit 2420. Hereafter, the same reference numeral is affixed to a component that is the same as in the seventh embodiment, and the explanation is omitted.

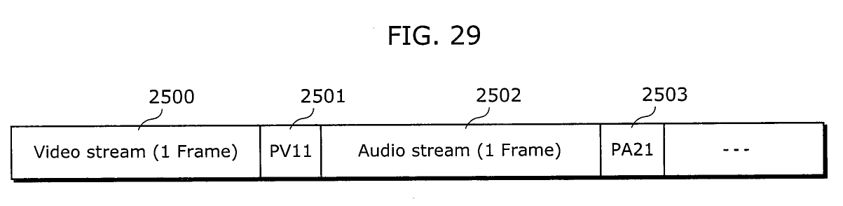

The user information addition unit 2420 is a processing unit which adds, for each frame, the number of execution steps etc. held in the execution step number hold table of the execution step number hold unit 2219 to the multiplex stream as user information, as shown in FIG. 29. More specifically, the user information addition unit 2420 reads the value from the execution step number hold table, and outputs it to the multiplex unit 107 in synchronization with audio and video frames.

FIG. 29 is a diagram showing the multiplex stream to which the user information of the 1^{st} frame is added. Here, information PV11 (2501), which indicates that the number of the video execution steps of the 1^{st} frame is less than the video execution step number threshold value PVt, is added as the user information after the video stream 2500 of the 1^{st} frame. In addition, information PA21 (2503), which indicates that the number of the audio execution steps of the 1^{st} frame is equal to or greater than the audio execution step number threshold value Pat, is added as the user information after the audio stream 2502 of the 1^{st} frame.

The multiplex stream (AV stream) to which the number of execution steps etc. are added is recorded in the recording medium 108 in such manner. The number of execution steps, etc. recorded in such manner show the throughput for each frame during encoding and, at the same time, show the throughput when decoding (reproducing) the stream generated by such encoding. Therefore, by referring to the number of execution steps etc. multiplexed in the stream when the stream recorded in the recording medium 108 is decoded, the throughput during decoding can be known immediately, and can be used to decide the signal processing mode for power reduction, as when encoding.

As mentioned above, according to the real-time processing apparatus in the present embodiment, since the user information addition unit 2420 is added to the seventh embodiment, and the stream to which the number of execution steps etc. is added is recorded in the recording medium 108, the signal processing mode for reducing power consumption can be decided while referring to the number of execution steps etc. recorded in the recording medium 108. As a result, power consumption can be reduced, not only during recording, but also during reproduction.

In addition, although, in the present embodiment, the user information (number of execution steps etc.) is added for each frame of audio and video, as the method of adding the user information, the user information is not limited to such a data structure, and for example, may also be collectively located at the head or the end of the multiplexed stream.

### Ninth Embodiment

Next, the real-time processing apparatus according to the ninth embodiment of the present invention will be described.

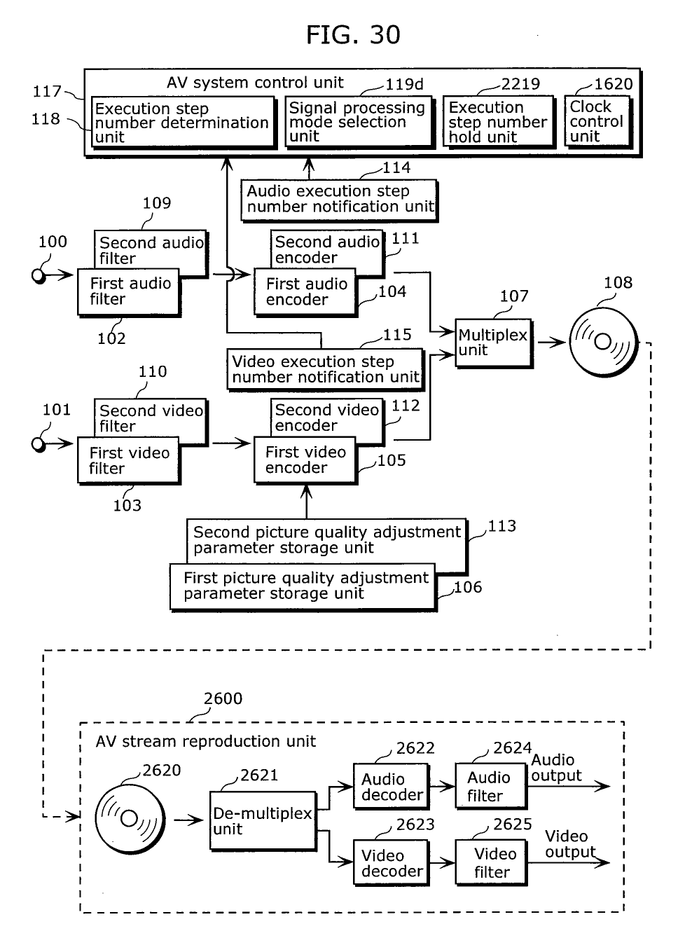

FIG. 30 is a block diagram showing the configuration of the real-time processing apparatus according to the ninth embodiment of the present invention. The real-time processing apparatus is a recorder/player that has the function of a recorder that, in real time, encodes and multiplexes inputted audio signal and video signal, and records this into the recording medium 108, and the function of a player that reproduces the stream recorded in the recording medium 2620. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and a second picture quality adjustment parameter storage unit 113) adjustment that can be selectively used, an audio visual system control unit 117 including an execution step number determination unit 118 and a signal processing mode selection unit 119d and an execution step number hold unit 2219 and a clock control unit 1620, a multiplex unit 107, a recording medium 108, and an AV stream reproduction unit 2600.

Comparing with the seventh embodiment shown in FIG. 26, the real-time processing apparatus is different in terms of the inclusion of the signal processing mode selection unit 119d in the fifth embodiment in place of the signal processing mode selection unit 119, and the addition of a clock control unit 1620 and an AV stream reproduction unit 2600. Hereafter, the same reference numeral is affixed to a component that is the same as in the seventh embodiment, and the explanation is omitted.

Although the signal processing mode selection unit 119d has the same functions as in the fifth embodiment, here, the signal processing mode for each frame is selected by referring to the execution step number hold table of the execution step number hold unit 2219, not only when the AV stream is recorded, but also when the AV stream is reproduced.

Although the audio visual system control unit 117 has the same functions as in the fifth embodiment, here, controlling so that each component 102 to 107, 109 to 113, and the AV stream reproduction unit 2600 operate/do not operate, according to the signal processing mode selected by the signal processing mode selection unit 119d, is executed not only when the AV stream is recorded, but also when the AV stream is reproduced.

Although the clock control unit 1620 has the same functions as in the fifth embodiment, here, the frequency of the clock supplied to each component is changed not only when the AV stream is recorded, but also when the AV stream is reproduced. In other words, when reproducing the AV stream, the frequency of the clock supplied to the AV stream reproduction unit 2600 is changed.

The AV stream reproduction unit 2600 is a processing unit that reproduces the AV stream recorded in the recording medium 2620. The AV stream reproduction unit 2600 includes a recording medium 2620 where the AV stream is recorded, a de-multiplex unit 2621 that reads AV stream from the recording medium 2620 and de-multiplexes the read AV stream, an audio decoder unit 2622 that decodes the compressed audio stream obtained by de-multiplexing, an audio filter unit 2624 that performs filtering on the decoded audio stream, a video decoder unit 2623 that decodes the compressed video stream obtained in the de-multiplexing, and a video filter unit 2625 that performs filtering on the decoded video stream.

The operation of the real-time processing apparatus in the present embodiment, configured in the above-mentioned manner, is the same as in the seventh embodiment when the AV stream is recorded, and is the same as in the recording in the fifth embodiment when the AV stream is reproduced.

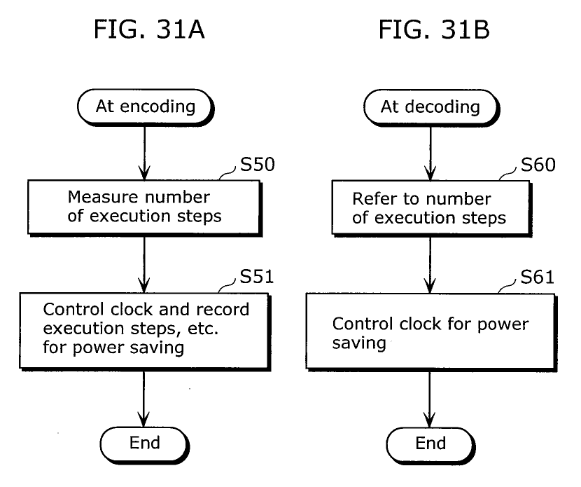

In other words, as shown in the flow chart of FIG. 31A, when recording the AV stream, the clock frequency is controlled on the basis of the number of execution steps actually measured (step S50), and the number of execution steps etc. are recorded in the execution step number hold table of the execution step number hold unit 2219 (step S51), so that power consumption is reduced.

On the other hand, as shown in the flow chart of FIG. 31B, when reproducing the AV stream, the signal processing mode selection unit 119d selects the signal processing mode referring to the number of execution steps etc. recorded in the execution step number hold table of the execution step number hold unit 2219 (step S60), and the clock control unit 1620 changes the frequency of the clock supplied to the AV stream reproduction unit 2600 according to the selected signal processing mode (step S61), so that power consumption is reduced.

As mentioned above, according to the real-time processing apparatus in the present embodiment, clock control can be performed while reproducing during the reproduction of the stream by adding the clock control unit 1620 and the AV stream reproduction unit 2600 to the seventh embodiment and using the execution step number information in the execution step number hold table shown in FIG. 27. As a result, power consumption can be reduced, not only during recording, but also during reproduction.

Although, in the present embodiment, power saving is carried out by controlling the clock frequency during the reproduction of the stream, the method of the power saving during reproduction of the stream is not be limited to the control of the clock frequency alone, and it is possible to reduce the power consumption by providing two kinds of decoders etc. with different throughput, as in the first embodiment, and operating the two kinds of decoders selectively according to the signal processing mode selection table for decoding.

### Tenth Embodiment

Next, the real-time processing apparatus according to the tenth embodiment of the present invention will be described.

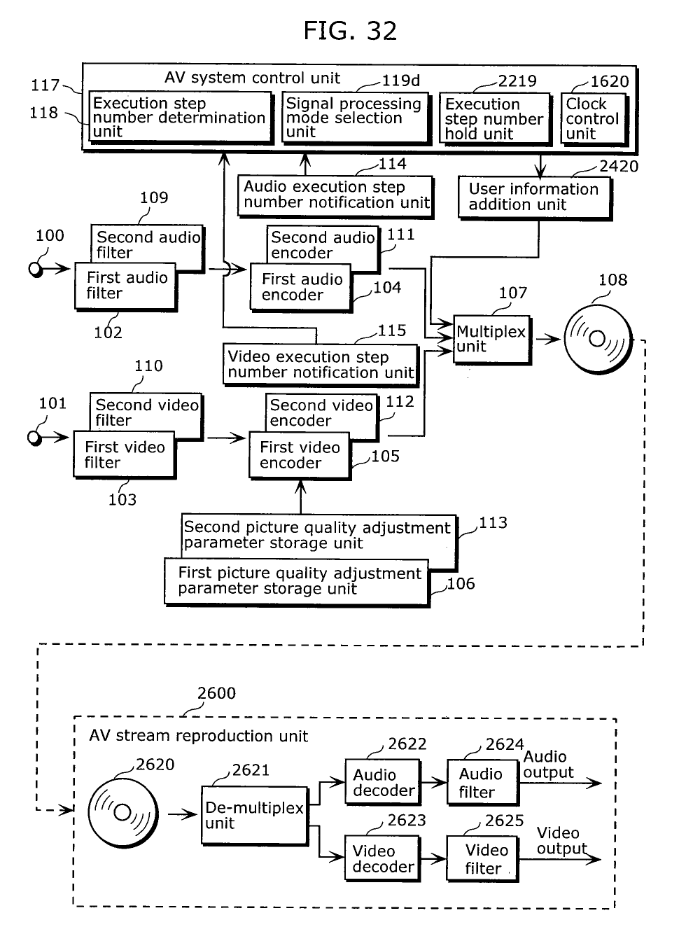

FIG. 32 is a block diagram showing the configuration of the real-time processing apparatus according to the tenth embodiment of the present invention. The real-time processing apparatus is a recorder/player that has the function of a recorder that, in real time, encodes and multiplexes inputted audio signal and video signal, and records this into a recording medium 108, and the function of a player that reproduces the stream recorded in the recording medium 2620. The real-time processing apparatus includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and a second picture quality adjustment parameter storage unit 113) that can be selectively used, an audio visual system control unit 117 including an execution step number determination unit 118 and a signal processing mode selection unit 119d and an execution step number hold unit 2219 and a clock control unit 1620, a multiplex unit 107, a recording medium 108, an user information addition unit 2420, and an AV stream reproduction unit 2600.

Compared with the first embodiment, the real-time processing apparatus further includes the execution steps number hold unit 2219, the clock controls unit 1620, the user information addition units 2420, and the AV stream reproduction units 2600, and is an apparatus with the functions in both the eighth embodiment and the ninth embodiment.

In other words, when the AV stream is recorded, the clock frequency is controlled by the clock control unit 1620 on the basis of the number of execution steps actually measured so that power consumption is reduced, and the number of execution steps etc. are recorded in the execution step number hold table of the execution step number hold unit 2219. In addition, the number of execution steps etc. held in the execution step number hold table is added, for each frame, to the multiplex stream as user information, by the user information addition unit 2420.

On the other hand, when reproducing the AV stream, the signal processing mode for reducing power consumption is selected by the signal processing mode selection unit 119d while referring to the number of execution steps etc. added to the stream recorded in the recording medium 108, and the frequency of the clock signal to AV stream reproduction unit 2600 is controlled by the clock control unit 1620 according to the selected signal processing mode.

As mentioned above, according to the real-time processing apparatus in the present embodiment, the stream to which the number of execution steps etc. are added by the user information addition unit 2420 is recorded in the recording medium 108, and during reproduction, the clock control for the power saving is executed by referring to the number of execution steps etc. added to the stream. As a result, power consumption can be reduced, not only during recording, but also during reproduction.

Although, in the present embodiment, the power saving is carried out by controlling the clock frequency during the reproduction of the stream, the method of the power saving during reproduction of the stream, is not limited to the control of the clock frequency alone, and it is possible to reduce the power consumption by providing two kinds of decoders etc. with different throughput, as in the first embodiment, and operating the two kinds of decoders selectively according to the signal processing mode selection table for decoding.

### Eleventh Embodiment

Next, the real-time processing apparatus according to the eleventh embodiment of the present invention will be described.

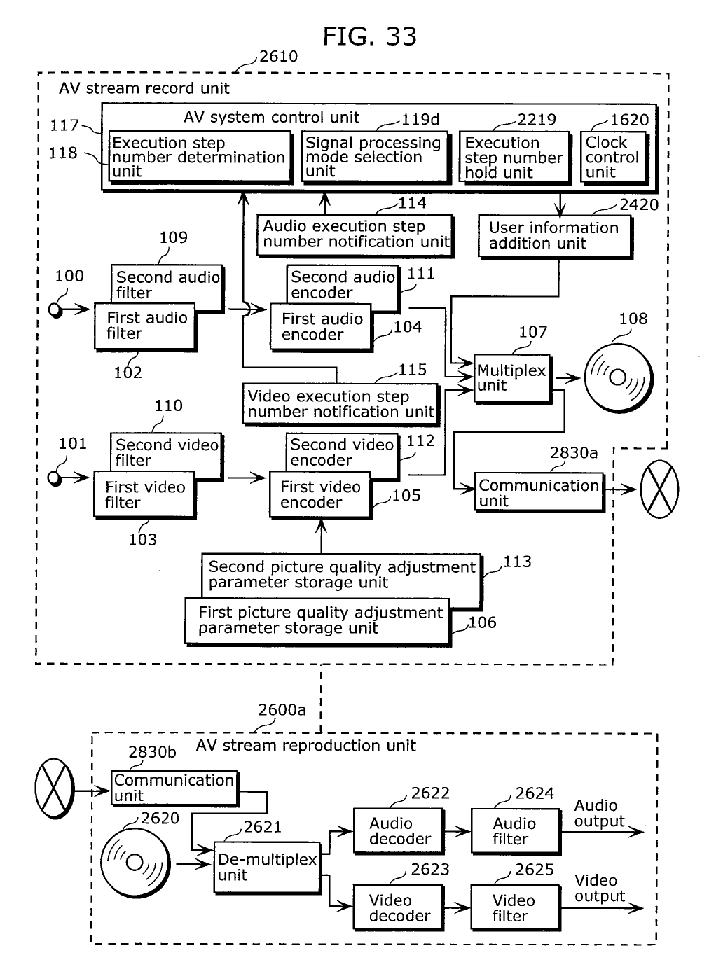

FIG. 33 is a block diagram showing the configuration of the real-time processing apparatus according to the eleventh embodiment of the present invention. The real-time processing apparatus is a recorder/player that includes the function of a recorder that, in real time, encodes and multiplexes inputted audio signal and video signal, and records this into a recording medium 108, and the function of a player that reproduces the stream recorded in a recording medium 2620, and includes an AV stream record unit 2610 and an AV stream reproduction unit 2600a.

The AV stream record unit 2610 includes an audio input terminal 100, two audio filters (a first audio filter 102 and a second audio filter 109) that can be selectively used, two audio encoders (a first audio encoder 104 and a second audio encoder 111) that can be selectively used, an audio execution step number notification unit 114, a video input terminal 101, two video filters (a first video filter 103 and a second video filter 110) that can be selectively used, two video encoders (a first video encoder 105 and a second video encoder 112) that can be selectively used, a video execution step number notification unit 115, two picture quality adjustment parameter storage units (a first picture quality adjustment parameter storage unit 106 and a second picture quality adjustment parameter storage unit 113) that can be selectively used, an audio visual system control unit 117 including an execution step number determination unit 118 and a signal processing mode selection unit 119d and an execution step number hold unit 2219 and a clock control unit 1620, a multiplex unit 107, a recording medium 108, an user information addition unit 2420, and a communication unit 2830a.

The AV stream reproduction unit 2600a is a processing unit that reproduces the AV stream recorded in the recording medium 2620. The AV stream reproduction unit 2600a includes a recording medium 2620 on which the AV stream is recorded, a de-multiplex unit 2621 that reads AV stream from the recording medium 2620 and de-multiplexes the read AV stream, an audio decoder unit 2622 that decodes the compressed audio stream obtained in the de-multiplexing, a audio filter unit 2624 that performs filtering on the decoded audio stream, a video decoder unit 2623 that decodes the compressed video stream obtained in the de-multiplexing, a video filter unit 2625 that performs filtering on the decoded video stream, and a communication unit 2830b.

The real-time processing apparatus is further differentiated from that in the tenth embodiment shown in FIG. 32 in terms of the addition of two communication units 2830a and 2830b. Hereafter, the same reference numeral is affixed to a component that is the same as in the tenth embodiment, and the explanation is omitted.

The communication unit 2830a is a communication interface that sends the AV stream (here, the AV stream to which the number of execution steps etc. is added when encoding) obtained by the multiplex unit 107 to an other apparatus through a communication network such as the Internet, etc.

The communication unit 2830b is a communication interface that receives the AV stream (here, the AV stream to which the number of execution steps etc. is added when encoding) sent from the other apparatus, and outputs it to the de-multiplex unit 2621.

In the real-time processing apparatus in the present embodiment, configured in the above-mentioned manner, transmission and reception of the AV stream to which the number of execution steps etc. is added can be carried out with the other apparatus which is connected via the communication network.

In other words, when functioning as a transmission station, the real-time processing apparatus generates, by the same processing as in the recording in the tenth embodiment, the AV stream to which the number of execution steps etc. is added during encoding, and transmits this to the other apparatus via the communication unit 2830a. More specifically, the clock frequency is controlled by the clock control unit 1620 on the basis of the number of execution steps actually measured, and the number of execution steps etc. are recorded in the execution step number hold table of the execution step number hold unit 2219, so that power consumption is reduced. Furthermore, the number of execution steps etc. held to the execution step number hold table is added to the multiplexed stream as the user information by the user information addition unit 2420, for each frame, and transmitted to the other apparatus via the communication unit 2830a.

On the other hand, when functioning as a receiving station, the real-time processing apparatus receives the AV stream to which the number of execution steps etc. is added during encoding, from the other apparatus via the communication unit 2830b, and the reproduction is executed by the same processing as in the reproduction in the tenth embodiment. More specifically, the signal processing mode for reducing power consumption is selected by the signal processing mode selection unit 119d while referring to the number of execution steps etc. added to the stream recorded in the recording medium 108, and the frequency of the clock to the AV stream reproduction unit 2600 is controlled by the clock control unit 1620 according to the selected signal processing mode.

As mentioned above, according to the real-time processing apparatus in the present embodiment, the clock control for power saving is executed through the transmission of the stream to which the number of execution steps etc. is added to the other apparatus, by the user information addition unit 2420, when functioning as a transmitting station and, on the other hand, by referring to the number of execution steps etc. added to the received stream when functioning as a receiving station. As a result, the power consumption can be reduced, not only during the generation of the AV stream (at the time of transmission), but also during reproduction (at the time of reception).

Note that although the real-time processing apparatus has the function of a transmitting station and the function of receiving station in the present embodiment, the present invention may be implemented as an apparatus that has only one of such functions. In other words, the present invention may be a transmitter configured of only the AV stream record unit 2610, and may also be a receiver configured of the audio visual system control unit 117 and the AV stream reproduction unit 2600.

### Twelfth Embodiment

Next, the real-time processing apparatus according to the twelfth embodiment of the present invention will be described.

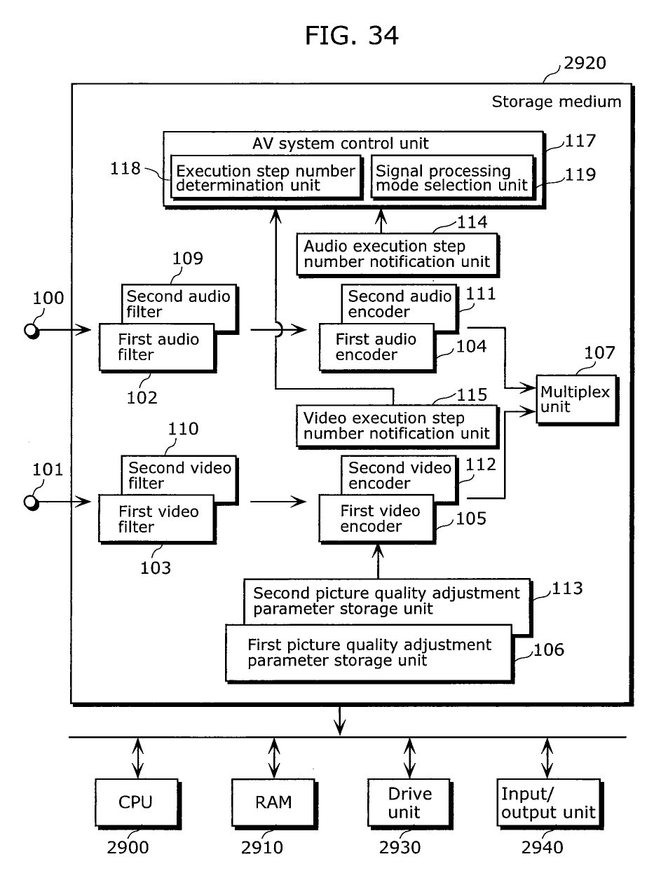

FIG. 34 is a block diagram showing the configuration of the real-time processing apparatus according to the twelfth embodiment of the present invention. This real-time processing apparatus is a recorder having a function that is the same as in the first embodiment, and includes a CPU 2900, a RAM 2910, a storage medium 2920, a drive unit 2930, and an input/output unit 2940.

The storage medium 2920 is ROM etc. that stores the program for implementing each component in the first embodiment with the software. The CPU 2900 is a processor that executes the program stored in the storage medium 2920. The RAM 2910 is a work memory used when various programs are executed. The drive unit 2930 is a unit that reads and writes from/to the recording medium 108. The Input/output units 2940 are various I/O interfaces.

As mentioned above, the real-time processing apparatus in the present embodiment is implemented with software. It goes without saying that, even with such a real-time processing apparatus, the object of the present invention is achieved as in the apparatus that is implemented with hardware. That is, power consumption is controlled by merely adding the simple determination processing of comparing the numbers of execution steps, and without performing the conventional complex arithmetic processing and requiring a special memory resource.

In addition, although, in the present embodiment, the program for implementing the functions of the real-time processing apparatus is stored in a memory such as the ROM, the program storage medium may also be a computer-readable recording medium such as a hard disc, a CD-ROM, etc.

Although the real-time processing apparatus according to the present invention is described thus far based on the embodiments, the present invention is not limited to these embodiments.

For example, configurations that are realized by arbitrarily combining the components in the respective embodiments, as well as configurations that implement variations of the respective embodiments that are easily conceived by one skilled in the art are included in the present invention.

Moreover, in the case where the real-time processing apparatus according to the present invention is implemented with the electronic circuit, it may be configured by plural IC (Integrated Circuit), and it may be configured by IC of the single-chip such as the LSI.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The real-time processing apparatus according to the present invention can be used as an apparatus that executes real-time processing while reducing power consumption, and can be used, for example as an AV stream generation apparatus, a recording apparatus, and a transmitting apparatus which generates an AV stream from an audio signal and a video signal in real time, or an AV stream reproduction apparatus, a receiving apparatus, and the like, which de-multiplexes an AV stream so as to reproduce an audio signal and a video signal in real time.

What is claimed is:

1. A real-time processing apparatus which processes an input signal in real time, said real-time processing apparatus comprising:
a first signal processing unit operable to perform signal processing in real time on the input signal;
a second signal processing unit operable to perform the signal processing with throughput smaller than throughput of the signal processing by said first signal processing unit, in real time on the input signal;
a step number measurement unit operable to measure a step number indicating a level of the throughput in the signal processing by said first signal processing unit or said second signal processing unit which is in operation; and
a controlling unit operable to execute control so that said first signal processing unit operates when the step number measured by said step number measurement unit is less then a threshold value provided beforehand, and said second signal processing unit operates when the step number is equal to or greater than the threshold value.

2. The real-time processing apparatus according to claim 1,
wherein said controlling unit includes:
a step number determination unit operable to compare the step number with the threshold value; and
a signal processing mode selection unit having a signal processing mode selection table, and operable to select, according to the signal processing mode selection table, a signal processing mode corresponding to a comparison result by said step number determination unit, the signal processing mode selection table indicating a correspondence between the comparison result by said step number determination unit and the signal processing mode which indicates an operation mode of said first signal processing unit and said second signal processing unit, and
said controlling unit is operable to execute control of the operation of said first signal processing unit and said second signal processing unit according to the signal processing mode selected by said signal processing mode selection unit.

3. The real-time processing apparatus according to claim 2,
wherein the input signal includes an audio signal and a video signal,
said first signal processing unit includes: a first audio processing unit operable to process the audio signal; and a first video processing unit operable to process the video signal,
said second signal processing unit includes: a second audio processing unit operable to process the audio signal with throughput smaller than the throughput in said first audio processing unit; and a second video processing unit operable to process the video signal with throughput smaller than the throughput in said first video processing unit,
said step number measurement unit includes: an audio processing step number measurement unit operable to measure the step number of said first audio processing unit or said second audio processing unit which is in operation; and a video processing step number measurement unit operable to measure the step number of said first video processing unit or said second video processing unit which is in operation, and
said controlling unit is operable to execute control so that: said first audio processing unit operates when the number of steps measured by said audio processing step number measurement unit is smaller than the threshold value, and said second audio processing unit operates when the number of steps is equal to or greater than the threshold value; and said first video processing unit operates when the number of steps measured by the video processing step number measurement unit is smaller than the threshold value, and said second video processing unit operates when the number of steps is equal to or greater than the threshold value.

4. The real-time processing apparatus according to claim 3, further comprising:
an audio filter operable to carry out filtering on the audio signal; and
a video filter operable to carry out filtering on the video signal,
wherein said controlling unit is operable to execute control so that: operation of said audio filter is turned ON when the number of steps measured by said audio processing step number measurement unit is smaller than the threshold value, and operation of said audio filter is turned OFF when the number of steps is equal to or greater than the threshold value; and operation of said video filter is turned ON when the number of steps measured by said video processing step number measurement unit is less than the threshold value, and operation of said video filter is turned OFF when the number of steps is equal to or greater than the threshold value.

5. The real-time processing apparatus according to claim 3, further comprising:
a first picture quality adjustment parameter storage unit operable to store a parameter used for picture quality adjustment by said first video processing unit and said second video processing unit; and
a second picture quality adjustment parameter storage unit operable to store a parameter used for picture quality adjustment with throughput smaller than the throughput of picture quality adjustment using the parameter stored in said first picture quality adjustment parameter storage unit,
wherein said controlling unit is further operable to control said first video processing unit and said second video processing unit so as to carry out picture quality adjustment using the parameter stored in said first picture quality adjustment parameter storage unit when the number of steps measured by said video processing step number measurement unit is less than the threshold value, and to carry out picture quality adjustment using the parameter stored in said second picture quality adjustment parameter storage unit when the number of steps measured by said video processing step number measurement unit is equal to or greater than the threshold value.

6. The real-time processing apparatus according to claim 3,
wherein said first audio processing unit and said second audio processing unit are operable to process the audio signal on a per frame basis,
said first video processing unit and said second video processing unit are operable to process the video signal on a per frame basis,
said audio processing step number measurement unit is operable to measure the step number on a per frame basis,
said video processing step number measurement unit is operable to measure the step number on a per frame basis, and
said controlling unit is operable to control the operation of said first audio processing unit, said second audio processing unit, said first video processing unit, and said second video processing unit for a subsequent frame, based on the comparison result between the step number and the threshold value for an immediately preceding frame.

7. The real-time processing apparatus according to claim 3, further comprising a quality mode determination unit operable to determine which of audio quality or video quality is to be given priority,
wherein said signal processing mode selection unit has, as the signal processing mode selection table: an audio priority selection table for carrying out signal processing with priority being given to audio signal quality; and a video priority selection table for carrying out signal processing with priority being given to video signal quality, and is operable to select the signal processing mode according to the audio priority selection table when said quality mode determination unit determines to give priority to the audio quality, and to select the signal processing mode according to the video priority selection table when said quality mode determination unit determines to give priority to the video quality.

8. The real-time processing apparatus according to claim 3,
wherein said video processing step number measurement unit is operable to measure, as the step number, the size of a motion vector of the video detected by said first video processing unit or said second video processing unit which is in operation.

9. The real-time processing apparatus according to claim 2.
wherein the input signal includes an audio signal and a video signal,
said first signal processing unit includes: a first audio processing unit operable to process the audio signal; and a first video processing unit operable to process the video signal,
said second signal processing unit includes: a second audio processing unit operable to process the audio signal with throughput smaller than the throughput in said first audio processing unit, and a second video processing unit operable to process the video signal with throughput smaller than the throughput in said first video processing unit, and
said real-time processing apparatus further comprises a multiplex unit operable to multiplex the audio signal obtained by said first audio processing unit or said second audio processing unit and the video signal obtained by said first video processing unit or said second video processing unit,
said step number measurement unit includes a throughput measurement unit operable to measure throughput of the multiplexed signal obtained by said multiplex unit, and
said controlling unit is operable to execute control so that said first audio processing unit and said first video processing unit operate when the throughput measured by said throughput measurement unit is less than the threshold value, and said second audio processing unit and said second video processing unit operate when the throughput measured by said throughput measurement unit is equal to or greater than the threshold value.

10. The real-time processing apparatus according to claim 1,
wherein said controlling unit includes a clock control unit operable to lower a frequency of a clock signal supplied to said first signal processing unit and said second signal processing unit when the step number measured by said step number measurement unit is equal to or greater than the threshold value provided beforehand.

11. The real-time processing apparatus according to claim 1,
wherein said step number measurement unit includes a electric current consumption measurement unit operable to measure electric current consumption of said real-time processing apparatus as the step number, and
said controlling unit is operable to execute control so that said first signal processing unit operates when the electric current consumption measured by said electric current consumption measurement unit is less than the threshold value provided beforehand, and said second signal processing unit operates when the electric current consumption measured by said electric current consumption measurement unit is equal to or greater than the threshold value.

12. The real-time processing apparatus according to claim 3, further comprising a step number hold unit operable to hold the step number measured by said step number measurement unit.

13. The real-time processing apparatus according to claim 12, further comprising:
a multiplex unit operable to multiplex the audio signal obtained by said first audio processing unit or said second audio processing unit and the video signal obtained by said first video processing unit or said second video processing unit; and
a user information addition unit operable to add the held step number held by said step number hold unit, as user information, to the multiplexed signals obtained by said multiplex unit.

14. The real-time processing apparatus according to claim 12,
wherein said first audio processing unit and said second audio processing unit are operable to encode the audio signal,
said first video processing unit and said second video processing unit are operable to encode the video signal,
said real-time processing apparatus further comprises a decoding unit operable to decode the encoded audio signal and the encoded video signal, and
said controlling unit includes a clock control unit operable to lower a frequency of a clock signal supplied to said decoding unit when the step number held by said step number hold unit is equal to or greater than the threshold value provided beforehand.

15. The real-time processing apparatus according to claim 13,
wherein said first audio processing unit and said second audio processing unit are operable to encode the audio signal,
said first video processing unit and said second video processing unit are operable to encode the video signal,
said real-time processing apparatus further comprises a decoding unit operable to de-multiplex the multiplexed signals to which said step number is added by said user information addition unit, and to decode the de-multiplexed signals, and
said controlling unit includes a clock control unit operable to lower a frequency of a clock signal supplied to said decoding unit when the step number added to the multiplexed signals is equal to or greater than the threshold value provided beforehand.

16. The real-time processing apparatus according to claim 15, further comprising:
a first communication unit operable to transmit the multiplexed signals to which the step number is added by said user information addition unit via a communication network; and
a second communication unit operable to receive the multiplexed signals to which the step number is added, which is transmitted via the communication network,
wherein said decoding unit is operable to de-multiplex the multiplexed signals received by said second communication unit, and to decode the de-multiplexed signals.
